(19) United States
(12) Patent Application Publication
(10) Pub. No.: US 2011/0101230 A1
(43) Pub. Date: May 5, 2011

(54) Advanced SNM Detector

(75) Inventor: Dan Inbar, Haifa (IL)

(73) Assignee: Dan Inbar, Haifa (IL)

(21) Appl. No.: 12/038,950

(22) Filed: Feb. 28, 2008

Related U.S. Application Data
(63) Continuation-in-part of application No. 11/463,112, filed on Aug. 8, 2006, now Pat. No. 7,847,260.
Application No. 11/463,112 is a continuation-in-part of application No. 11/348,040, filed on Feb. 6, 2006.
(60) Provisional application No. 60/649,541, filed on Feb. 4, 2005.
(60) Provisional application No. 60/651,622, filed on Feb. 11, 2005.
(60) Provisional application No. 60/654,964, filed on Feb. 23, 2005.
(60) Provisional application No. 60/706,013, filed on Aug. 8, 2005.
(60) Provisional application No. 60/706,752, filed on Aug. 10, 2005.
(60) Provisional application No. 60/707,154, filed on Aug. 11, 2005.
(60) Provisional application No. 60/709,428, filed on Aug. 19, 2005.
(60) Provisional application No. 60/710,891, filed on Aug. 25, 2005.
(60) Provisional application No. 60/596,769, filed on Oct. 20, 2005.
(60) Provisional application No. 60/596,814, filed on Oct. 24, 2005.
(60) Provisional application No. 60/597,354, filed on Nov. 28, 2005.
(60) Provisional application No. 60/597,434, filed on Dec. 1, 2005.
(60) Provisional application No. 60/597,435, filed on Dec. 1, 2005.
(60) Provisional application No. 60/597,569, filed on Dec. 10, 2005.
(60) Provisional application No. 60/597,629, filed on Dec. 14, 2005.
(60) Provisional application No. 60/767,379, filed on Mar. 23, 2006.
(60) Provisional application No. 60/892,254, filed on Mar. 1, 2007.

(30) Foreign Application Priority Data
Feb. 6, 2005 (IL) 166701

(51) Int. Cl. G01T 3/08; G01T 1/20

(52) U.S. Cl. 250/370.05; 250/370.11

(57) ABSTRACT

A detector for detecting SNM and or RDD radiation. The detector comprising: a plurality of elongated organic scintillator segments arranged in a side by side array; and at least one pair of light sensors optically coupled to ends of each of the scintillator segments such that they receive light from scintillations produced in the scintillator and generate electrical signals responsive thereto.

### RELATED APPLICATIONS

The present application is a continuation in part of U.S. patent application Ser. No. 11/463,112 filed Aug. 8, 2006 (published Dec. 28, 2006 as US Patent Publication 2006/0289775) and claims the benefit under 35 U.S.C. §1.19(e) of U.S. Provisional application, 60/767,379 filed Mar. 23, 2006, 60/891,551 filed Feb. 26, 2007, 60/891,727 filed Feb. 27, 2007, 60/891,729 filed Feb. 27, 2007, 60/891,738 filed Feb. 27, 2007, 60/891,751 filed Feb. 27, 2007, 60/892,254 filed Mar. 1, 2007 and 60/892,893 filed Mar. 5, 2007. U.S. patent application Ser. No. 11/463,112 is a continuation in part of U.S. patent application Ser. No. 11/348,040 filed Feb. 6, 2006 (published Dec. 28, 2006 as US Patent Publication 2006/0284094) and U.S. patent application Ser. No. 11/690,150 filed Mar. 23, 2007 which claims the benefit under 35 U.S.C. §1.19(e) of U.S. Provisional Applications 60/649,541 filed Feb. 4, 2005; 60/651,622 filed Feb. 11, 2005; 60/654,964 filed Feb. 23, 2005. This application also claims the benefit under 35 U.S.C. §1.19(e) of U.S. Provisional Applications: 60/706,013 filed Aug. 8, 2005; 60/706,752 filed Aug. 10, 2005; 60/707,154 filed Aug. 11, 2005; 60/709,428 filed Aug. 19, 2005; 60/710,891 filed Aug. 25, 2005; 60/596,769 filed Oct. 20, 2005; 60/596,814 filed Oct. 24, 2005; 60/597,354 filed Nov. 28, 2005; 60/597,434 filed Dec. 1, 2005; 60/597,435 filed Dec. 1, 2005, 60/597,569 filed Dec. 10, 2005; 60/597,629 filed Dec. 14, 2005.

All of the above mentioned applications and publications are incorporated herein by reference. Patent publications 2006/0289775 and 2006/0284094 are referred to herein as “the above referenced publications.”

### FIELD OF THE INVENTION

The present invention is in the field of threat detection and in particular the detection of nuclear/radiological threats.

### BACKGROUND OF THE INVENTION

For a number of years governments have been struggling with how to keep terrorists from trafficking in special nuclear materials (SNM) and devices containing such materials and radiological dispersion devices (RDD). Such materials include weapon grade Uranium (WGU) and weapon grade Plutonium (WGP) and radioactive sources used for RDD. Such trafficking can take place by people, car, truck, container, rail, ship or other means.

There is a long perceived need for a cost/effective system to screen, detect, locate and identify SNM or RDD materials or devices that are being transported. Furthermore there is a long felt need for an effective means to scan, locate and identify suspected areas in which those threats may be present.

Such screening is difficult in practice due, at least in part, to the environment in which it is done. Firstly, environmental radiation (including terrestrial and atmospheric radiation) of gamma rays and neutrons is substantial. Secondly, benign Normally Occurring Radiological Materials [NORM] like K-40 occur in nature and are present in many benign cargos. For example, kitty litter, plywood, concrete and bananas, emit substantial amounts of benign radiation. Additionally, humans undergoing nuclear medicine imaging or radiation treatment using implanted radioactive seeds can emit sizeable amounts of radiation. These and other “natural” or “benign” sources of radiation: this phenomena coupled with the ability to shield (using a heavy metal like lead to shield gammas and low specific gravity materials to shield neutrons) the SNM and RDD, make simple detection schemes either ineffective in finding nuclear radiological threats or prone to a poor receiver operating characteristic (ROC), for example a large percentage of false positives.

Substantial numbers of false positives produce a large number of screened objects (hereinafter, unless otherwise specified, the term object relates to vehicles, trains, shipping containers, packages, luggage, people, cargo and other items that might contain/carry nuclear/radiological threats) that have to be searched or otherwise vetted manually, making such simple systems practically useless for screening large numbers of objects. At present the leading means to screen RDD and SNM trafficking vehicles are the so called next generation Advanced Spectroscopic Portals (ASP) developed recently for the U.S. DHS DNDO.

More than 90% of the ASP systems use an array of 8 or 16 relatively small NaI(Tl) scintillators (e.g., 0.1×0.1×0.4 meter), to detect the gamma energy spectroscopic signatures of SNM and RDD, and a small array of He-3 Neutron detectors to detect and count neutron emissions.

ASP systems do not provide nuclear imaging and other SNM RDD signatures detection. ASP systems detection performance is limited primarily due to the high cost of NaI detectors, which limits the system detection area/sensitivity. Because of the high price and practical cost constraints, the NaI(Tl) and He-3 detectors, their number is small [typically the ASP NaI detectors have a sensitive area is 0.64 meter2] relative to the distance from the threat radiation source, resulting in a small solid angle of the detector as viewed by the threat. This limits the detection sensitivity and selectivity.

It is noted that while, for a given stand-off distance, the total detected radiation (benign radiation and the threat radiation) is proportional to the solid angle subtended by the detectors at the emitting radiation sources, the background radiation sigma (statistical standard deviation) is proportional to the square root of the solid angle. Thus, a 100 fold increase in solid angle (≈detector size) results in a 10 fold increase in detection certainty (number of standard deviations above the mean) to threats in a given screening condition. For example, if the small area (i.e. small solid angle) could reliably detect a source with 10 microCurie of activity, the 100 times larger detector will detect 1 microCurie with the same certainty (same rate of true and false detections, given the same geometry and background radiation).

Furthermore, the ASP detects only one threat signature for WGU and RDD—its gamma spectroscopic signature, since such materials do not emit neutrons in an amount much different 30 from background. For WGP it detects also a second signature its neutron emission. Having only a single signature makes the system less reliable.

In addition, ASP systems do not provide several other SNM-RDD signatures such as 1D, 2D and 3D nuclear imaging, temporally based signatures such as cascade isotopes (e.g. Co60) doublets detection and gamma/neutron salvo emanating from spontaneous fission of SNM. Having such additional signatures would improve the ROC.

These and other limitations are known in the art and drove the DHS DNDO to publish the BAA-06-01 document. This publication states the need to come up with transformational technologies which will provide a much better than ASP SNM signatures detection performance, such as lower cost detectors, improved energy resolution detectors, the use of other than gamma energy spectroscopy SNM-signatures (e.g spontaneous fission signature, imaging), detection of incident gamma or neutron directionality and other means that improve the overall system ROC.

The prior art teaches that organic scintillators (OS) provide a highly robust and stable material that is easily formable in many shapes and has the best detection sensitivity when cost per detected Gamma events is considered. On the other hand, there is a common belief in the prior art that organic scintillators, although some non-spectroscopic OS based portals have been used in the past, fail to provide acceptable ROC as they do not provide energy resolution (or at best a very limited one) in the context of nuclear threat detection. This explains why organic scintillators haven not been used for direct gamma spectroscopy isotope identification in nuclear radiological spectroscopic portals (NRSPs) (in the way NaI(Tl) and HPGe detectors are used in ASP) to identify and/or provide reliable energy window of SNM, RDD and NORM selected gamma energies. Furthermore, it is accepted that for all practical purposes screening portals organic scintillators have a poor gamma efficiency or “stopping power” at energies above 300 keV as compared to NaI(Tl). A review of this issue is given in: Stromswold, D. C. et al., “Comparison of plastic and NaI(Tl) scintillators for vehicle portal monitor applications” in: Nuclear Science Symposium Conference Record, 2003 IEEE, Vol (2) pp. 1065-1069. October 2003. The disclosure of this paper is incorporated herein by reference.

In recent studies related to anti-neutrino detection (see http://arxiv.org/ftp/physics/papers/404/0404071.pdf) and in other publication of the same group (see F. Suekane et al., “An overview of the KamLAND 1; K-RCNP International School and mini-Workshop for Scintillating Crystals and their Applications in Particle and Nuclear Physics Nov., 17-18, 2003, KEK, Japan, it has been shown that extremely large (8 meter diameter) expensive (>$100 million, due mainly to the very large detector size and large number of large [18″] photomultiplier tubes (PMTs) used) liquid scintillator detectors can provide gamma energy resolution which is close to that of NaI(Tl). Such devices are not practical for large scale (or even small scale) deployment for threat detection due to their geometry and astronomical cost. The disclosure of this paper is incorporated herein by reference.

R. C. Byrd et al., in “Nuclear Detection to Prevent or Defeat Clandestine Nuclear Attack”, IEEE Sensors Journal, Vol. 5 No. 4, pp. 593-609, 2005, present a review of prior art of SNM-RDD screening, detection and identification techniques. The disclosure of these papers is incorporated herein by reference.

In a PNNL report by Reeder, Paul L. et al., “Progress Report for the Advanced Large-Area Plastic Scintillator (ALPS) Project: FY 2003 Final” PNNL-14490, 2003, a PVT light collection efficiency of 40% for a 127 cm long detector is described. It should be noted that a straight forward extension to 4 meters length of the PNNL OS approach would have resulted in less than 25% light collection and less than 15% light collection for a 6 m long detector. The disclosure of the PNNL report is incorporated herein by reference.

Further information on the state of the art can be found in the Background section of and referenced prior art listed and included by reference in the above referenced US patent application and provisional patent applications.

### SUMMARY OF THE INVENTION

An aspect of some embodiments of the invention is concerned with a detector for nuclear [i.e. SNM and/or RDD] threat detection.

In an exemplary embodiment of the invention, the detector is segmented such that gamma neutron and muons particles can be transmitted substantially without impediment between segments while light generated by scintillations within a segment stays substantially within that segment.

Optionally, the detector is a planar detector formed as a series of elongated polygonal detector segments placed side by side. Preferably, the detector is also polygonal segmented in a direction normal to the plane of the detector, by light reflecting, low Z radiation passing barriers, such that light from scintillations that occur at different depths in the detector are confined to the polygonal detector segments in which they occur. Since the barriers are substantially transparent to gamma and neutron radiation, gamma and neutron radiation that contains residual energy after a scintillation can pass substantially unimpeded to a different segment. For nuclear threat detection in objects, such as trucks and maritime containers a 4 m×4 m×0.5 m detector assembly is typically polygonal segmented into 200 elongated segments, each having a length of 1 to 6 meters and a cross section of more than 5 cm However, the cross-section of the elongated segments can have various other forms in addition to the rectangular form indicated above.

In an exemplary embodiment of the invention, the light collection efficiency of the detector segments is enhanced by the use of light transparent sheets having an index of refraction higher than the index of refraction of the organic scintillators.

In an exemplary embodiment of the invention, at least two photo-sensors, such as a photomultiplier tube (PMT), are optically coupled to the ends of each segment. The coupled photo-sensors collect light from the ends of the scintillator segments.

By comparing the time and/or intensity of the scintillation light detected at the two photo-sensors (or signals generated by the photo-sensors in response to the scintillation light), the position of the initial scintillation within of the segment can be estimated using one or both of time of flight (TOF) techniques and the ratio of the PMT signals. As the total charge emanating from the two PMTs is integrated, it represents the total collected light, which can be used to determine the deposited energy of the scintillation, especially after the segment is calibrated as described herein.

Thus, a two dimensional array of such elongated segment (having a variety of cross sections such as polygonal, rectangular, round, triangle cross section) can be used to localize the position of the incident particle scintillation within the detector assembly in three dimensions. By summing the signals produced by the individual PMTs in response to the scintillations, determine the incident particle energy, assuming full energy deposition within the detector volume.

It should be understood that such scintillators can be made of any scintillating material. However, the present inventor has found that organic scintillators and especially liquid organic scintillators (LS) have the requisite requirements for detection of nuclear threats. Typical LS for use in the invention comprises a cocktail of (for a 4 m×4 m×0.5 m volume detector) 12 kg PPO, 6.3 m3 normal-dodecane and 1.6 m3 pseudo cumene. The barriers can be of many materials. One useful material is thin nylon sheets, coated with a thin layer of reflecting means. [e.g. reflecting paint, high index of refraction cladding layer, Brightness Enhancement Film (BEF manufactured by 3M)] In some embodiments of the invention, the segments are formed by creating such partitions in a vessel filled with LS material.

In an exemplary embodiment of the invention, the probability of escape quanta is further reduced, beyond the fact that rather large (e.g. 2×4×0.5 m) segmented detectors are used. In this exemplary embodiment some or all peripheral segments include QS which is loaded with high Z material (e.g. lead). This decreases the probability that escape quanta will escape the segmented detector. The penalty is some reduction in light output (resulting in decreased energy resolution) due to reduced light optput of the high Z loaded OS segments

While this cocktail is optimal for γ detection and spectroscopy it is not necessarily optimal for neutron detection and neutron-gamma identification. To identify incident gamma particles from incident neutrons several techniques can be used, such as pulse shape discrimination [PSD] which is known in the art.

A problem that might arise in implementing a gamma/neutron segmented OS detector relates to the fact that OS and especially LS which are optimal for gamma spectroscopy are not necessarily optimal for gamma/neutron segregation using PSD and other known gamma-neutron identification techniques.

In an exemplary embodiment of the invention, the above mentioned problem is alleviated by using at least two types of OS. One which is particularly favorable to PSD gamma-neutron discrimination (e.g. BC-519, BC-501a) will be placed at the periphery of the segmented detector cells while another OS (e.g. BC-505) which optimizes gamma spectroscopy will be used for the rest of the segments.

A common problem of the prior art SNM-RDD screening portals is the need to keep a rather large safety distance between nuclear detectors which are mounted on the side of the screening lane This distance reduces the particle detection efficiency

In an exemplary embodiment of the invention, the rate of detected particles emanating from the screened item is increased while the rate of background environmental radiation [e,g. terrestrial gammas, atmospheric neutrons] is decreased. This is done by placing the detectors (or-one detector) adjacent to the top and/or bottom of the screened item.

In an embodiment of the invention, the detector is a 2D imaging detector. It is capable of imaging suspected one or both of gamma rays and neutrons. In one embodiment, the detector is fitted with high Z (e.g. lead) collimators for gamma collimation. Alternatively or additionally, the detector is formed of segments, some of which act as collimators for other segments, since they absorb both gammas and neutrons. This second option is also useful for imaging neutrons, which the present inventor believes has never been previously achieved in WGP threat detection devices.

In a preferred embodiment of the invention gamma and/or neurton collimation is at least partly achieved by using more than one type of scintillators. This is achieved by using at least two types of organic scintillators arranged in an alternating geometry. When gamma imaging is sought at least one type of high Z material loaded OS is used and the other OS not (or much less) high Z material loaded. The high Z loaded segments form a collimation effect which substantially retains gamma and/or neutron detection efficiency while enhancing collimation. Alternatively when neutron imaging is sought at least one OS is loaded with high neutron absorbing (e.g, gadollinum) material and at least one with low neutron stopping power.

Alternatively or additionally, gross direction capability for both incident gammas and neutrons is achieved even without collimators. As to gamma rays, the incident gamma rays produce a number of scintillations as they travel through the detector segments. The side of the detector, the 2D positions facing the screened item, sub-nanosecond event times, and deposited energy of these scintillations are determined, and a gross direction of incidence of the gamma ray is estimated from analysis of positions of the first and second scintillations emanating from the incident particle interaction with individual segments. This methodology is especially useful in reducing terrestrial and atmospheric radiation by a veto on particles that most probably come from a direction other than the direction of the screened object. As to neutrons, it is possible to determine if the neutrons entered the detector from the top, sides, front side facing the screened object or rear side facing to screened object, since neutrons of typical WgP spontaneous fission energies are captured within the first 5-10 cm of OS detector material. This enables the rejection of more than a half the environmental neutron radiation and an increase in selectivity (e.g., improved ROC) of the system.

Optionally, since a number of images are obtainable as the vehicle passes the large detector, linear (partial views tomography) using one or two slanted collimation means or transaxial tomography can be performed by using more than two detectors. There is also a possibility to provide concurrently linear and transaxial tomography. Techniques for performing such tomography in the field of X-ray and nuclear tomography are well known, but have not been applied to nuclear threat detection.

An aspect of some embodiments of the invention is concerned with large area detectors (optionally imaging detectors) preferably having >75% stopping power at 0.1-3 MeV gamma energy range suitable for screening a threat “vehicle” such as a person, car, truck, container, package, train, aircraft or boat. Generally speaking, such detectors are very expensive due to the cost of the detector assembly, the costs of scintillators and/or the costs of the relatively large numbers of photo-sensors or direct nuclear detectors like high purity germanium HPGe detectors that are required. A segmented OS (e.g. LS or Plastic Scintillator [PS]) detector according to some embodiments of the invention allows for the construction of a large detectors having extremely high sensitivity for both neutrons and gammas, NaI (Tl) like gamma energy resolution, temporal resolution and intrinsic gamma and neutron spatial resolution that are suitable for reliable nuclear/radiological threat detection for the cost of the most advanced prior art methods.

In some embodiments of the invention, the detector, the associated circuitry and software algorithms are capable of identifying and rejecting incident gammas which do not deposit all of their initial energy in the detector. The identification and rejection of so called “escape quanta” events allows for better gamma spectroscopy isotope identification and/or energy windowing.

In some embodiments of the invention a loci dependent light collection efficiency correction is applied to the detector segments energy signals. This correction mitigates a significant variable of loci dependent energy signals, resulting in a better energy resolution.

In a preferred embodiment of the invention, a segmented LS detector having high light reflecting partitions, coupled to PMTs photo cathodes which cover more than 73% of the segments cross section is used. In some embodiments, LS filled optical couplers are used to match the sizes of the PMT and the segments. Such segments use OS such as the PPO based LS described above which have a “mean attenuation length” larger than 15 meters, an index of refraction of approximately 1.5 to match the PMT glass index of refraction and PPO emission spectra which matches the response spectra of Bialkali PMT's. The PMT face is preferably in contact with the LS.

This ensemble may, under some circumstances, provide near 50% or even more light collection efficiency, even for long 3-6 meter detector segments. This increases the number of photoelectrons per MeV at the PMTs, resulting in better energy resolution timestamp and neutron/gamma ID precision. It should be noted that one of the reasons that the prior art believes that OS detectors had poor gamma spectroscopic ability was the low light collection efficiency of elongated scintillators that might be useful for threat detection.

In some embodiments of the invention an OS Scintillator assembly larger than 1×1×0.4 meter is used to allow most of the incident gammas having energies of more than 2.6 MeV to substantially deposit their full energy in the Scintillator assembly, thus eliminating most of the gamma energy resolution loss due to escape quanta associated with smaller detectors.

In a typical embodiment, a scintillation detector approximately 50 cm deep can have a 4×4 or 6×4 (length×height) meter front face. Larger devices can be constructed, and smaller sizes, such as 2×2 m can be useful for “car size only” or pallets lanes. Such large detectors have a number of potential advantages. One advantage is that the efficiency of capture of both gammas and neutrons emanating from the screened field of view is greatly improved, due to the large subtended angle that they present to the radiation sources. If radionuclide imaging using high Z collimators is implemented this high gamma sensitivity hike is reduced. A second advantage is that the efficiency of detecting temporally coincident SNM RDD signatures like cascaded isotopes and spontaneous fission gamma/neutron salvos is increased. For example, doublet capture is greatly improved, since the probability of doublet capture is roughly the square of the probability of singlet capture. A substantial percentage of doublet capture results in improved discrimination between some doublet emitting threats like Co-60 (used in some RDD designs) and benign radiation and improved sensitivity to threatening radiation. It should be noted that the probability of random chance detectability of doublets is extremely low as the background radiation rate is low approximately 1-3 K counts per second per square meter, while the doublets detection temporal coincidence window is short (about 20 Nanosecond).

Another advantage of large detectors, especially imaging detectors, is the amount of time each portion of a moving vehicle is screened. Taking into account the movement of the vehicle, every portion of a moving vehicle is captured for almost 40 times as long by a four meter long imaging detector as by a detector having an ASP 10 cm detection length in the direction of movement of the vehicle. This allows for x40 increase in signal to background radiation discrimination which translates into the detection of threats with less than ⅙ the activity.

Another aspect of the invention is to use the unique ability of the segmented OS detectors, to concurrently detect and segregate Gammas and/or Neutrons which interact with the front and back of the detectors and identify the incident particles (back or front) gross directionality. This mode of operation can, for example, screen items moving in the dual detector lane at their nominal screening velocity (e.g. 5 MPH). If the object arouses suspicion it can be further screened by moving it to the back side of a detector and screening it for a longer duration (e.g. 600 sec). This extended scan time further increases the detection accuracy by factor proportional to the square root of the screening time (e.g. for 600 sec scan it further improves screening threat detectability by a factor of 24.5).

Another aspect of this advantage is that compared to the ASP requirement to move the vehicle at 5 MPH, we can theoretically move the vehicle at 5×40=200 MPH and get the ASP number of detected particles. In practice the length of the detector allows screening at highway speeds of 60 MPH while getting close to twice the detectability of an ASP at 5 MPH. Thus, it is possible to get, at highway speed, a higher detectability then that specified for ASP at only 5 MPH. An aspect of some embodiments of the invention is concerned with a non-imaging and/or imaging detector that can detect both gamma rays and neutrons and provide spectral and/or spatial imaging of the radiation of at least one of the kinds. Optionally, both kinds are screened. This allows for the use of a single detector for sensing a wide range of threat signatures.

An aspect of some embodiments of the invention is concerned with a detector that can identify the general or gross direction of an incident gamma and/or neutron particle independent of the use of a collimator and/or shielding. In an embodiment of the invention, at least some events that are incident from a direction other than a direction from which they are expected when screening an object, can be rejected. This allows for a decrease in background radiation both from environmental radiation and from radiation emanating from other objects (e.g. nuclear medicine patients outside the field of screening). In addition, it enables the rejection of events that enter from the back, sides, top and bottom of the detector. Rejecting events that do not come from the expected direction can increase the reliable threat detectability of the system many fold.

An aspect of some embodiments of the invention is concerned with imaging guided spectroscopy. In this process, the imaging capability of the detector is used to detect point sources that could be identified as an RDD or SNM or a case of NORM point source at some limited probability (e.g. three to four standard deviations over the ocean of background). To further identify if the point source is a benign (e.g. NORM) or threat, a spectroscopic isotope ID is then applied over a limited area (for example, 1 square meter) around the suspected point source. This eliminates from the spectra most of the non-target background radiation, greatly improving the ability to identify the spectral signature of SNM or RDD.

An aspect of some embodiments of the invention is the provision of one or a plurality of energy windowed images on an isotope-by-isotope basis. This technique is used in nuclear medicine imaging to provide maps of individual isotopes. Providing maps for different isotopes in threat detectors improves the image and its point source contrast over the ocean of background radiation.

An aspect of some embodiments of the invention is concerned with an organic scintillator with both intrinsic spatial and temporal resolution and spectrographic properties to discriminate between isotopes. In an embodiment of the invention, the presence of escape quanta can be detected for a given incident particle, and the event vetoed. This can provide a significant improvement in spectroscopic isotope identification.

The combination of high light detection efficiency and high and uniform collection efficiency associated with loci dependent light collection variation correction and the small rate of escape quanta (due to the large detector) allows for gamma spectroscopic isotope I.D. that is similar to that of detectors with NaI(Tl) scintillators. It should be noted that the exact design of the detector is dependent on a tradeoff between gamma spectroscopic identification and imaging capability. If imaging capability is desired, then some kind of collimation may be required. This reduces the capture efficiency based threat signatures performance. On the other hand, if high particle collection efficiency is desired, for spectroscopy, and temporal coincidence signatures (e.g. cascading isotopes I.D. spontaneous fission gamma/neutron I.D.) detection (discussed below) no collimators are more desirable. In some embodiments, a combination of areas that have collimation and areas that do not have collimation provide a compromise design. Such embodiments are discussed herein.

An aspect of some embodiments of the invention is related to a novel class of detectors which combines high spatial resolution over some areas of the detector and high system sensitivity over the other areas of the detector.

As indicated above, only gross directionality of the incoming radiation can generally be determined without collimation.

In particular, it is noted that gamma rays give up their energy in an organic scintillator material, in a series of time and geometrically spaced events (e.g. Compton interactions), each of which produces a separate scintillation. In general, it is preferred to have the size of the segments matched to a mean length between scintillations (this indicates a compromise between low [100 KeV gammas having a short distance] and high energy gammas [2.6 MeV having a long distance]), such that the position of each event in the detector is, with high probability, in a different segment. The time constant of a single scintillation is the same order of magnitude (a few nsec) as the time between scintillations of the same event, hence they can not easily be discriminated from each other by time. If, however, they occur in different segments, their leading edge timestamp, deposited energy and 2D location are separately detected and measured. This allows the use of algorithms used in Compton imaging techniques to detect the gross directionality of the incident gamma. This allows rejection of gammas that are incident from the back face and to a great extent terrestrial and atmospheric gammas and neutrons.

The requirements for neutron detection are different. In general, the energy (other than the rest energy) is given up over a short path length. This path length is within one or two segments and thus only gross direction can be determined for such events, for example whether the neutron entered the front detector face, the top or the back detector face.

To determine improved directionality for either type of particle, some collimation is often desirable. Since the spatial resolution required is very modest (˜0.4-1 Meter FWHM), the collimation can be modest as well.

In an embodiment of the invention, some areas of the detector have relatively high collimation and other areas have low or no collimation, but are relatively thick. In a preferred embodiment of the invention, the thick and thin areas are interleaved and the thick areas provide some or all of the collimation of the thin areas. This detector self-collimation method allows for imaging of both gammas and neutrons.

In some embodiments of the invention, collimation is applied only for gamma rays and optionally only over a part of the detector to allow for both imaging and high detection (capture) efficiency.

In general, in prior art nuclear threat detection systems the detection sensitivity for gamma rays is so small (due to the small size of the detectors) that the detection rate for doublets does not allow for consideration of doublets or spontaneous fission γ/N salvos, for identification of cascading sources.

An aspect of some embodiments of the invention is related to multi-lane chokepoints where a single detector is used to scan threats in lanes on both sides of the detector. Thus, it is possible to scan N lanes nuclear threat portals in which only N+1 detectors are used instead of 2N detectors to form gamma and/or neutron screening of threats in adjoining lanes. This saving in number of detectors uses the unique property of the detector to identify whether an incident gamma and/or neutron entered from the back or front of each detector assembly.

An aspect of the invention is concerned with screening for vehicles moving at highway speeds. As this design allows the fabrication of 4-6 meter long detectors (in the vehicle's travel direction) vs. the 0.1 meter of ASP, the detection sensitivity is 40-60 times that of an ASP. Thus, detectors of the type described herein can provide sensitivity to a target moving at 60 mph that is >3 times that for ASP for targets that move at 5 mph. This level of sensitivity opens the possibility of screening of vehicles in highway traffic.

Optionally, the detector is covertly mounted in a screening vehicle providing a roadside and on the road moving optionally covert screening portal.

Optionally, the detectors can be covertly mounted under the road and/or in tunnels, walls or bridges.

While the invention is described mainly with respect to closely packed segments with rectangular cross-sections, in some embodiments of the invention the individual detector segments have non rectangular cross section such as a cylindrical form to improve the scintillation light collection efficiency to improve light collection efficiency and/or uniformity thus improving gamma energy resolution. Alternatively or additionally, the segments are spaced from each other.

In some embodiments of the invention, the SNM-RDD screening portal radionuclide images are fused or correlated with CCTV imaging of the vehicle. The position of the image in the vehicle can be used as an indicator of whether the detected material is a threat. This has been discussed in the above referenced regular U.S. patent application Ser. No. 11/348,040.

In some embodiments of the invention, the partitioning of the large detector consists of various sizes of detector sections, with smaller partitions being used near the front face of the detector.

There is thus provided, in accordance with an embodiment of the invention, a detector for detecting nuclear radiation threats, the detector comprising:

a plurality of elongated scintillator segments arranged in a side by side array; and

at least one pair of light sensors optically coupled to ends of each of the elongated scintillator segments such that they receive light from scintillations produced in the scintillator segments and generate electrical signals responsive thereto.

In an embodiment of the invention, the segments are separated by partitions that are substantially transparent to gamma radiation and are reflectors for light.

Optionally, the segments are contiguous, separated only by said partitions. Alternatively, the Scintillator segments are at least partly non-contiguous.

Optionally, the segments have a rectangular cross-section perpendicular to the elongated direction. Alternatively, the segments have a circular cross-section perpendicular to the elongated direction.

In an embodiment of the invention, the scintillator segments comprise an organic Scintillator, optionally a liquid organic scintillator.

Optionally, the light sensors have input face plates and wherein the faceplates are in direct contact with the liquid organic Scintillator.

Optionally, the detector includes: a controller that receives the electrical signals and generates an image of the sources of radiation that cause the scintillations.

Optionally, the Scintillator produces scintillations responsive to incoming neutrons, and the detector further comprises:

a controller that receives the electrical signals and determines the positions of the incident neutrons on the detector.

Optionally, the Scintillator produces scintillations responsive to incoming neutrons, and the detector further comprises:

a controller that receives the electrical signals and generates an image of the sources of neutron radiation that cause the scintillations.

Optionally, the detector includes:

a controller that receives the electrical signals, and produces an energy value, the energy value being responsive to the electrical signals, wherein the energy value is corrected based on the location of the scintillation within the scintillator segment.

In an embodiment of the invention, the detector includes:

a plurality of collimators on a front face of the organic scintillator that block radiation that would be detected by the said detector from parts of the radiation field.

Optionally, the plurality of collimators restricts block radiation over only a portion of the front face.

Optionally, the plurality of elongated scintillators forms a detector having a front face having a total area greater than 1 meter by 1 meter.

In an embodiment of the invention for detecting nuclear threats that generate one of both of neutrons and gammas, wherein the photo-detectors receive light of scintillations in the liquid organic scintillator caused by gammas and neutrons; and including:

a controller that receives the electrical and generates both a count of the incident neutrons and a spectroscopic energy analysis of the gammas.

In an embodiment of the invention, wherein the plurality of polygonal elongated scintillators forms a detector having a front face and a back face and the scintillators produce scintillations in response to radiation that enters the detector via the front face and the back, the detector comprising:

a controller that receives the electrical signals, and discriminates between the radiation entering the front and rear faces.

In an embodiment of the invention where the plurality of elongated scintillators forms a detector having a front face, the detector comprising:

a controller that receives the electrical signals, generates a gross direction of incidence of the incident radiation from said signals, without considering the presence or absence of collimation and rejects at least some incident radiation particles that do not come from a direction at which a suspected source is situated.

In an embodiment of the invention where the plurality of elongated polygonal scintillators forms a detector having a front face, the front face is not flat, and alternating portions of the front face extend further front than other portions.

In an embodiment of the invention a plurality of said arrays are stacked in a direction perpendicular to the direction of said array to form a three dimensional array of said elongated polygonal scintillator segments.

In a embodiment of the invention the plurality of polygonal segmented detectors comprises a plurality of segments formed of a series of light reflecting low atomic weight partitions placed in a vessel filled with liquid scintillator material, such that the partitions form the individual elongated segments.

Optionally, the detector includes:

a controller that receives the electrical signals and generates a timestamp reflecting the time that the light arrives at the photo-detector.

Optionally, the sum of the signals relating to an incident particle is proportional to the total energy deposited in the detector by the incident particle.

Optionally the light sensors are photomultiplier tubes (PMTs).

Optionally, the controller corrects the timestamps for systematic variations of PMT light channel delays.

Optionally, the controller corrects the signals for loci dependent light collection efficiency systematic variations.

Optionally, the thickness of the stacks is deep enough to allow full energy deposition in the detector for more than 60% of 2.6 MeV gamma particles incident at the center of the front face.

Optionally the detector is utilized in a screening portal having a lane, wherein a detector is placed at one side of the lane, or on each side of the lane.

Optionally, a plurality of polygonal segmented detectors are spaced to form a plurality of vehicle lanes and where a single detector is utilized to detect radiation from adjoining lanes.

Optionally the detector is utilized in a screening portal having a lane wherein the at least one detector surrounds at least 50% of the lane.

Optionally the detector is utilized in a screening portal having a lane wherein at least one detector surrounds more than 50% of the portal opening or completely surrounds the portal opening.

Optionally, the detector is mounted in a vehicle to provide a portable nuclear and or radiological threat area and/or road screening device.

Optionally the detector includes a controller that identifies a plurality of scintillations as emanating from a single incident particle based on a temporal window within which they fall and their spatial proximity within the detector.

Optionally, the detector function is disguised or hidden so that it detects threats in a covert manner.

Optionally, the detector includes:

a source of activating radiation that stimulates emission of radiation from SNM and radiation shielding materials, wherein the scintillator segments are positioned to receive said stimulated emission.

Optionally the detector includes:

a controller that receives the electrical signals and generates a tomographic image of radionuclide sources of the radiation.

Optionally, the scintillator is a PPO based liquid scintillator.

There is further provided, in accordance with an embodiment of the invention, a system for detection of radiation signatures of SNM and RDD devices and materials from a screened object, comprising:

At least one scintillator which produces scintillations when impinged by gamma and neutron radiation;

a plurality of optical sensors optically coupled to the at least one scintillator such that they receive light from scintillations produced in the scintillator and generate electrical signals responsive thereto; and

a controller that receives the signals and performs a multi-signature detection of threats including a plurality of the following threat detection inputs or characterizations:

(a) gamma spectroscopy isotope signature;

(b) gamma imaging morphologic signature;

(c) neutron counting;

(d) neutron imaging;

(e) cascaded isotopes doublets or triplets signature;

(f) SNM spontaneous fission signature;

(g) comparison with optical images of the screened object; and

(h) gross directionality of incidence of radiation as compared to the direction of the screened object.

Optionally, the at least one scintillator comprises a segmented organic scintillator comprising at least four elongated segments.

Optionally, the scintillator comprises a liquid scintillator.

Optionally, the detector comprises at least three, four, five or more of said threat detection inputs or characterizations.

There is further provided, in accordance with an embodiment of the invention, a detector for detecting incident neutrons, comprising;

at least one scintillator that produces scintillations responsive to incoming neutrons produced by WPG;

a plurality of photo-detectors that receive light of the scintillations and produces electrical signals responsive thereto; and

a controller that receives the electrical signals and generates an image of the sources of neutron radiation that cause the scintillations.

There is further provided an SNM detection system, effective to screen vehicles moving at a velocity greater than 40 MPH.

There is further provided a method of SNM detection comprising screening a suspected item by placing it before at least one detector while the item is stationary to increase the number of radiation events captured by the detector.

There is further provided, in accordance with an embodiment of the invention a detector for detecting radiation, comprising:

an organic scintillator;

a plurality of photo-detectors that receive light of scintillators in the organic scintillator and generates electrical signals responsive thereto; and

a controller that receives the light and generates an image of the sources of radiation that cause the scintillations.

There is further provided, in accordance with an embodiment of the invention a detector for detecting incident neutrons, comprising;

a scintillator that produces scintillations responsive to incoming neutrons;

a plurality of photo-detectors that receive light of the scintillations and produces electrical signals responsive thereto; and a controller that receives the electrical signals and determines the positions of the incident neutrons on the detector.

There is further provided, in accordance with an embodiment of the invention a detector for detecting radiation, comprising:

an organic scintillator element;

a plurality of light sensors functionally connected to the scintillator such that they receive light from scintillations produced in the scintillator and generate electrical signals responsive thereto; and

a controller that receives the electrical signals, and produces an energy value, the energy value responsive to the electrical signals, the energy value being corrected based on the location of the scintillation within the scintillator element.

There is further provided, in accordance with an embodiment of the invention a detector for detecting radiation, comprising:

an organic scintillator;

a plurality of light sensors functionally connected to the scintillator such that they receive light from scintillations produced in the scintillator and generate electrical signals responsive thereto; and

a plurality of collimators on a front face of the organic scintillator that restrict the field of view of portions of the scintillator.

Optionally, the plurality of collimators restricts the field of view over only a portion of the front face.

There is further provided, in accordance with an embodiment of the invention a detector for detecting radiation, comprising:

a substantially planar organic scintillator having an input face greater than 1 meter by 1 meter;

a plurality of light sensors functionally connected to the scintillator such that they receive light from scintillations produced in the scintillator and generate electrical signals responsive thereto; and

a controller that receives the electrical signals, and produces an energy value, the energy value responsive to the electrical signals, the energy value being corrected based on the location of the scintillation within the scintillator element.

There is further provided, in accordance with an embodiment of the invention a detector for detecting nuclear threats that generate one of both of neutrons and gammas, the detector comprising:

a liquid organic scintillator that produces light scintillations responsive to interactions with gammas and neutrons that are incident thereon;

a plurality of photo-detectors that receive light of scintillations in the liquid organic scintillator and generates electrical signals responsive thereto; and

a controller that receives the electrical signals and generates both a count of the incident neutrons and a spectroscopic energy analysis of the gammas.

There is further provided, in accordance with an embodiment of the invention a detector for detecting radiation, comprising:

a substantially planar scintillator having at least a front and back side;

a plurality of light sensors functionally connected to the scintillator such that they receive light from scintillations produced in the scintillator from radiation that enters the scintillator via the front and rear faces and generate electrical signals responsive thereto; and

a controller that receives the electrical signals, and discriminates between the radiation entering the front and rear faces.

There is further provided, in accordance with an embodiment of the invention a detector for scanning to determine a source of radiation, comprising:

a substantially planar scintillator having a front surface for receiving radiation;

a plurality of light sensors functionally connected to the scintillator such that they receive light from scintillations produced in the scintillator from radiation that enters the scintillator and generate electrical signals responsive thereto; and

a controller that receives the electrical signals, generates a gross direction of incidence of the radiation from said signals, without considering the presence or absence of collimation and rejects at least some scintillations that do not come from a direction at which a suspected source is situated.

There is further provided, in accordance with an embodiment of the invention a detector for detecting radiation, comprising:

an organic scintillator unit having a front face and a back; and

a plurality of light sensors functionally connected to the scintillator such that they receive light from scintillations produced in the scintillator from radiation that enters the scintillator and generate electrical signals responsive thereto;

wherein the front face is not flat, and wherein alternating portions of the front face extend further front than other portions.

### BRIEF DESCRIPTION OF THE DRAWINGS

Exemplary, non-limiting, embodiments of the invention are described below in conjunction with the following drawings, in which like numbers are used in different drawings to indicate the same or similar elements.

FIG. 1A is a schematic drawing illustrating a general view of part of a threat-detecting portal in accordance with an embodiment of the invention;

FIG. 1B is a schematic drawing illustrating a general view of part of SNM-RDD portal which outlines two screened vehicles screened simultaneously. Each vehicle can be screened at a different velocity in accordance with an embodiment of this invention.

FIG. 1C illustrates the side views of FIG. 1B having a converging collimator at one screening lane in accordance with an embodiment of the invention;

FIGS. 1D and 1E are schematic drawings illustrating a general view of part of a threat-detecting portal having detectors above and below the screened object in accordance with an embodiment of the invention;

FIGS. 2C and 2D illustrate the side views of FIG. 1E in accordance with an embodiment of the invention.

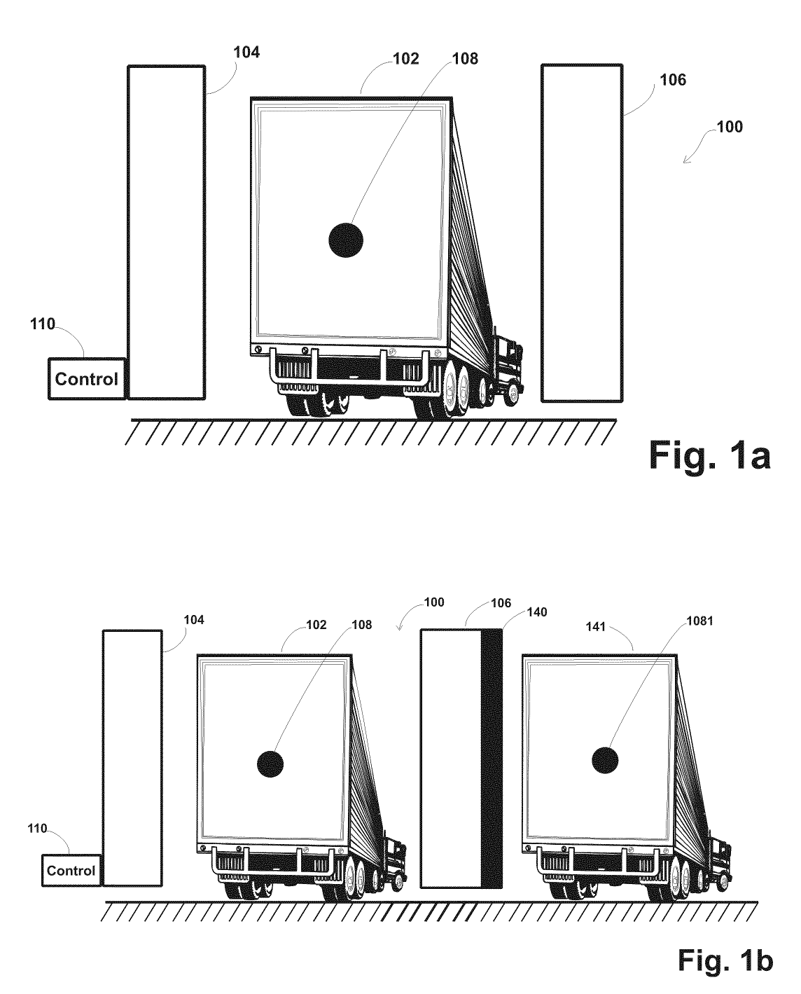

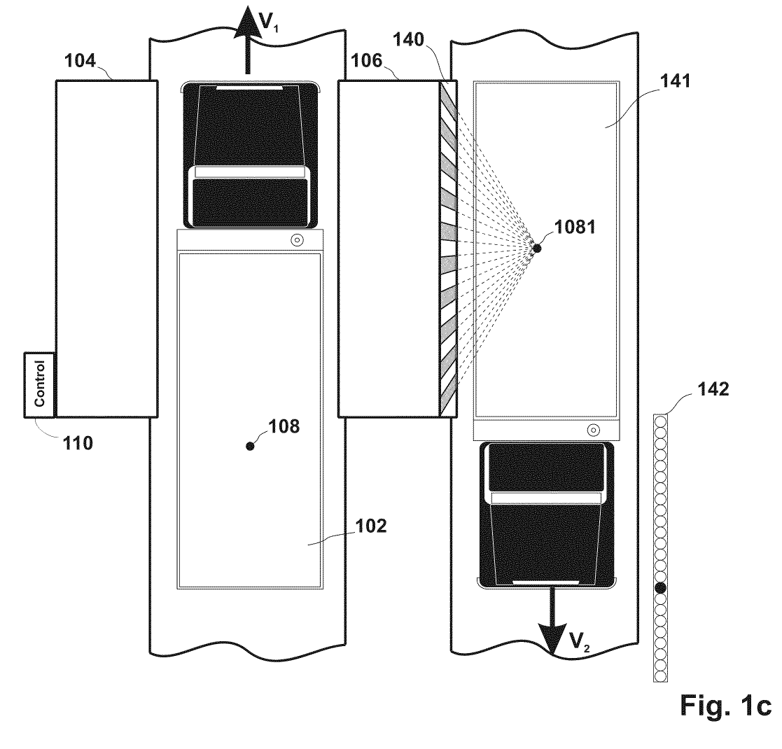

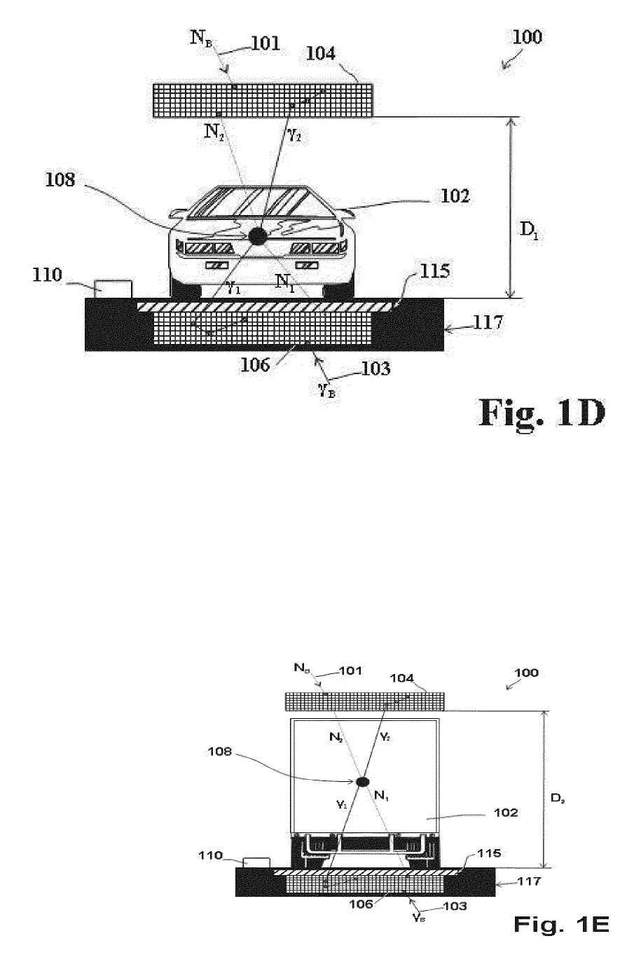

FIG. 1C is a top view of 1B in accordance with an embodiment of the invention;

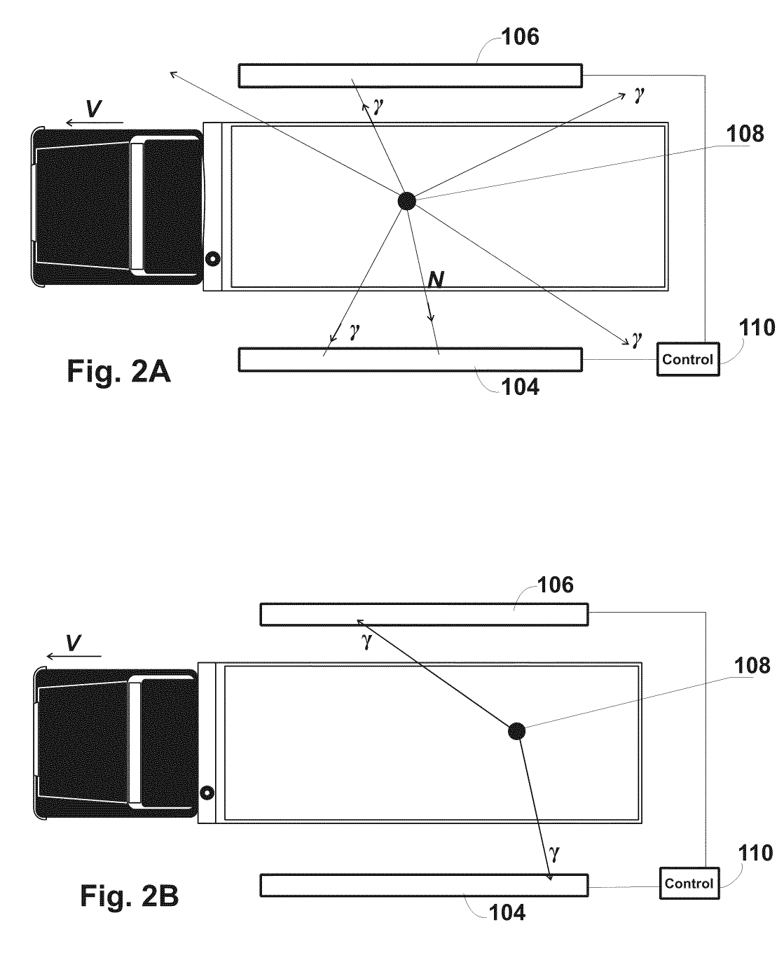

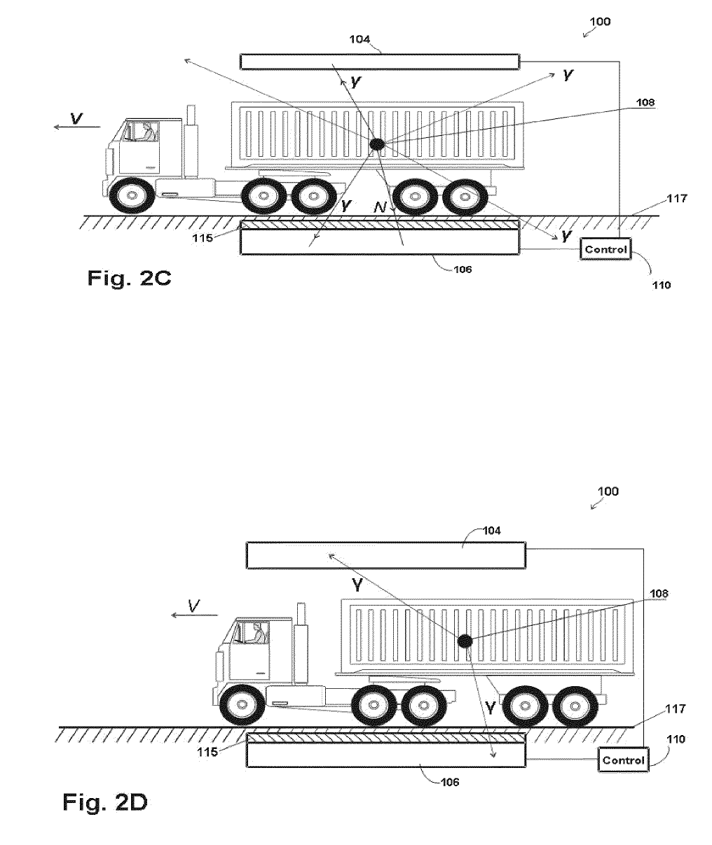

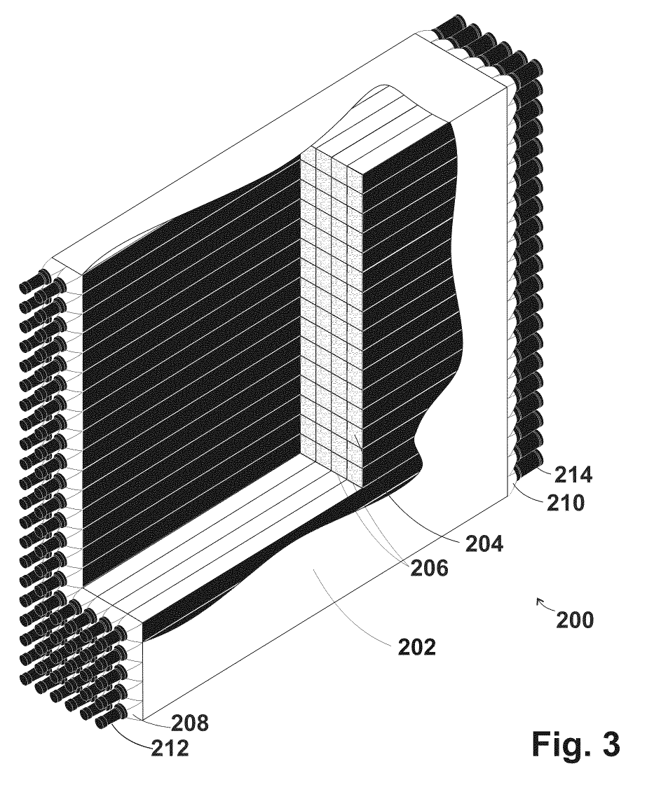

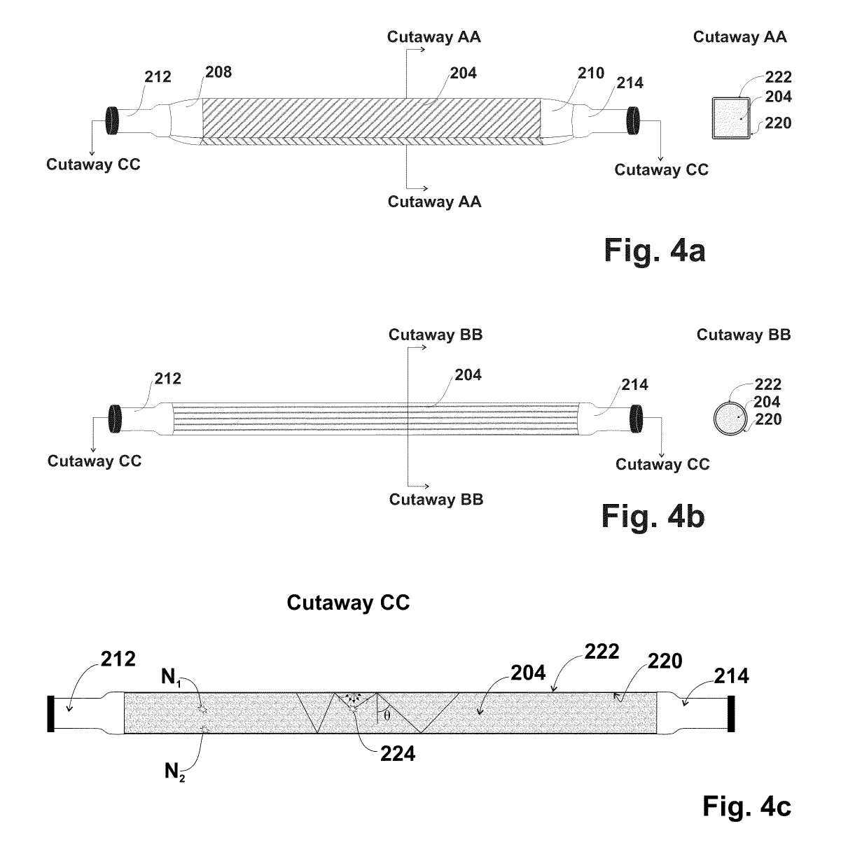

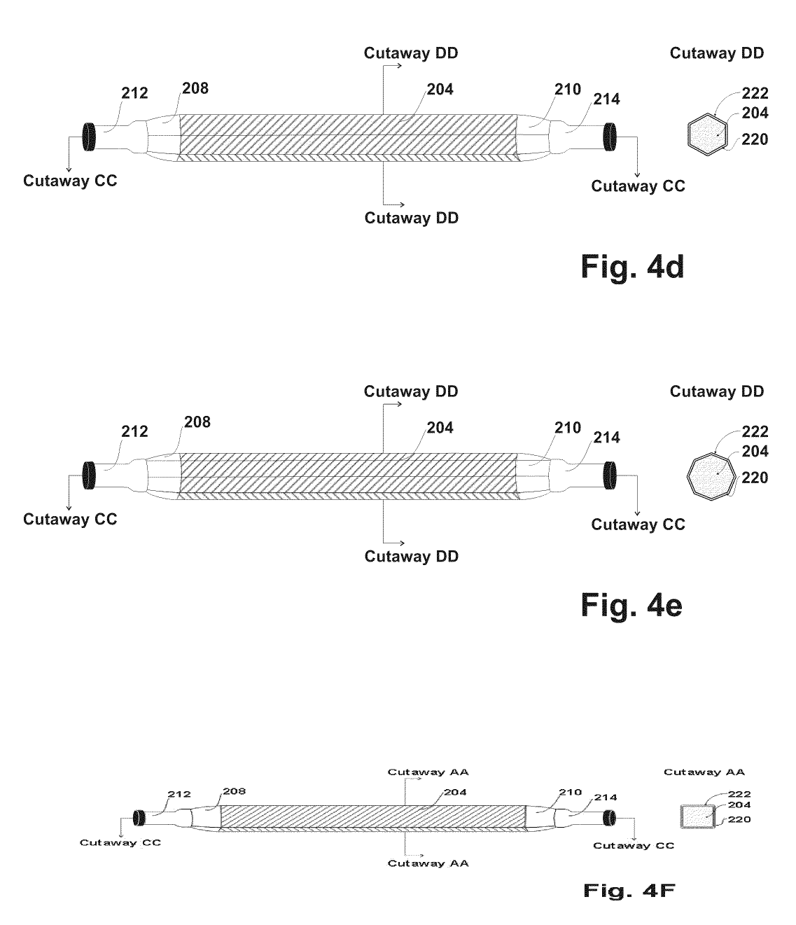

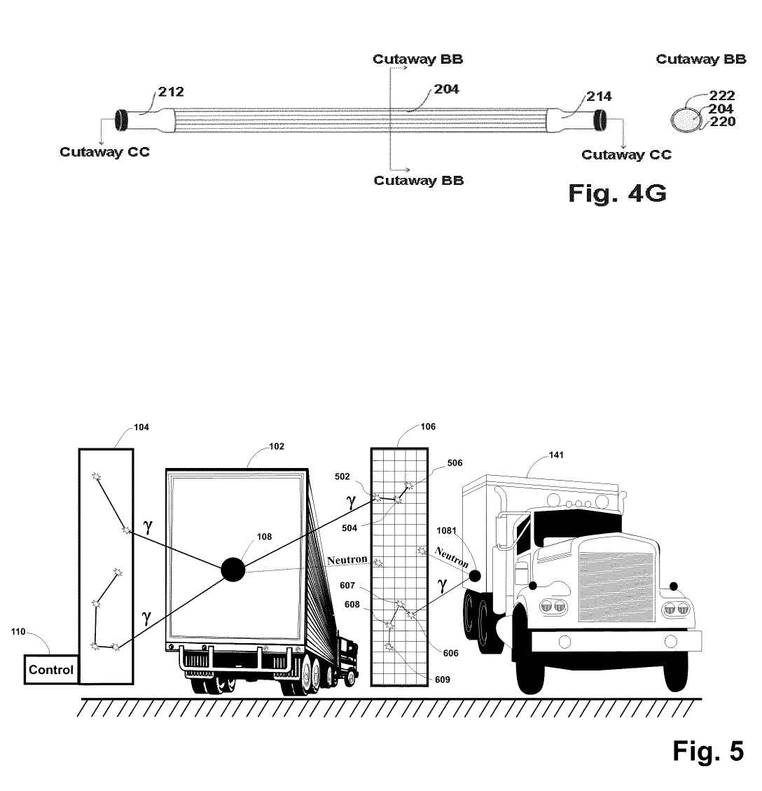

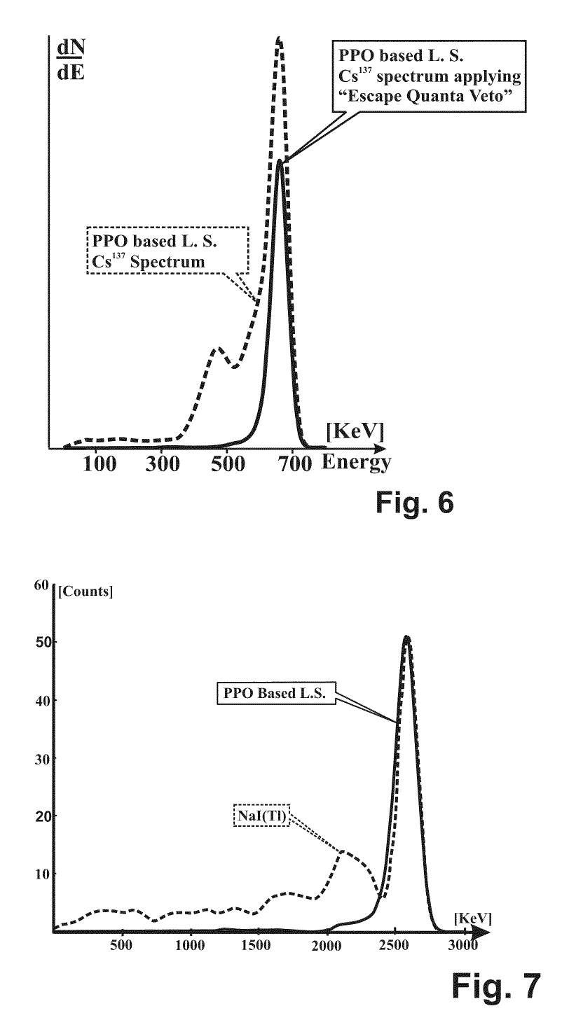

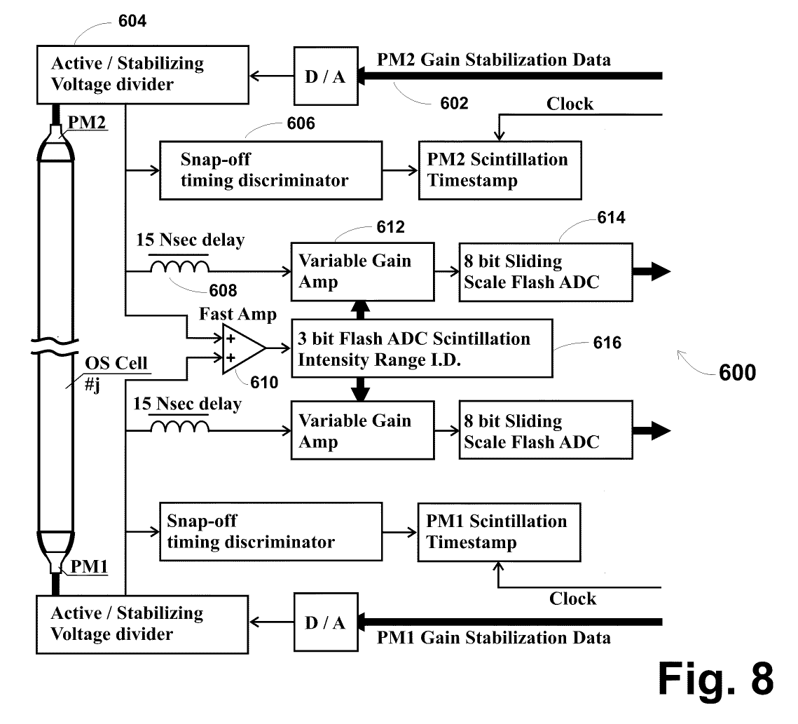

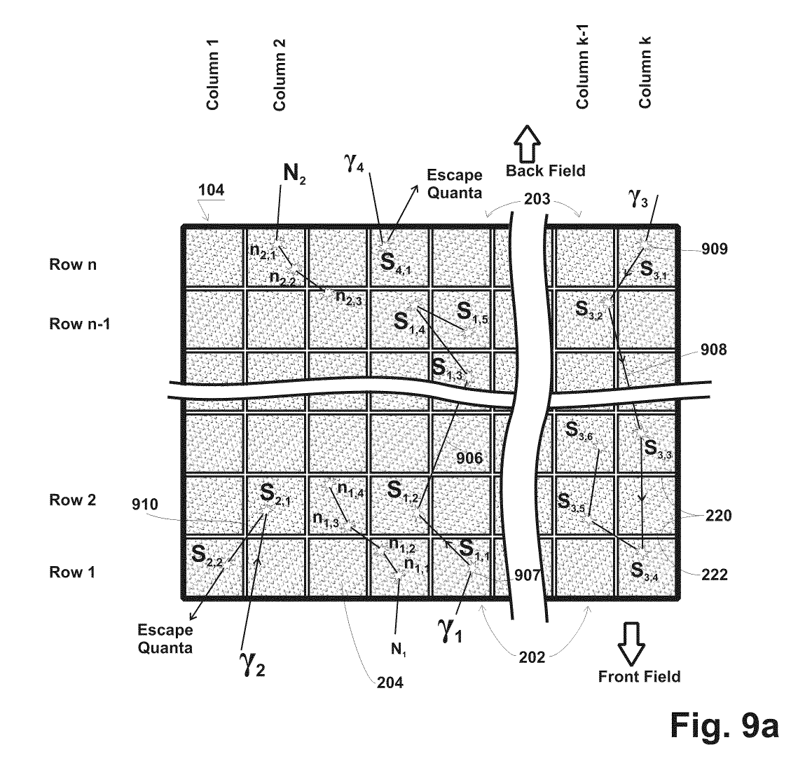

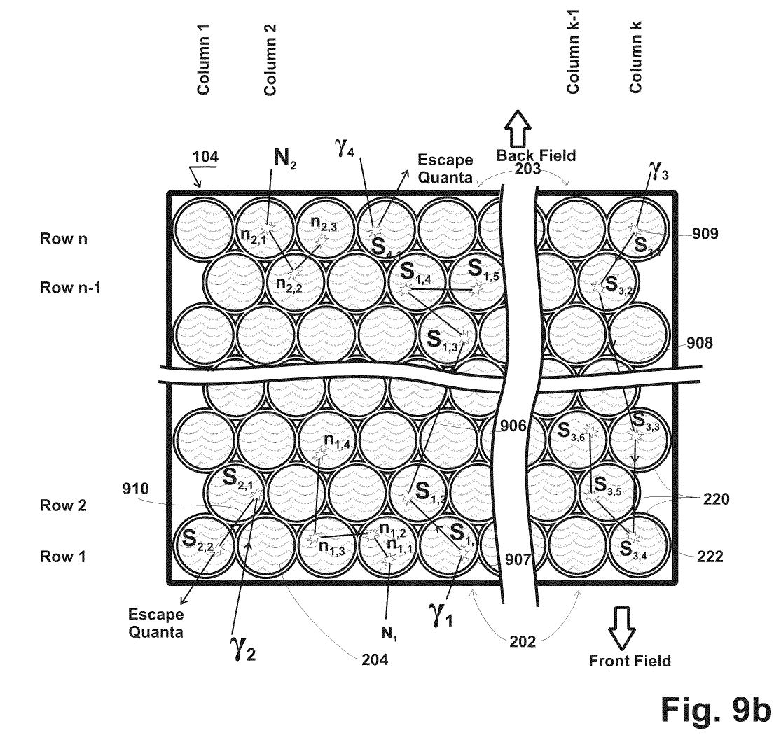

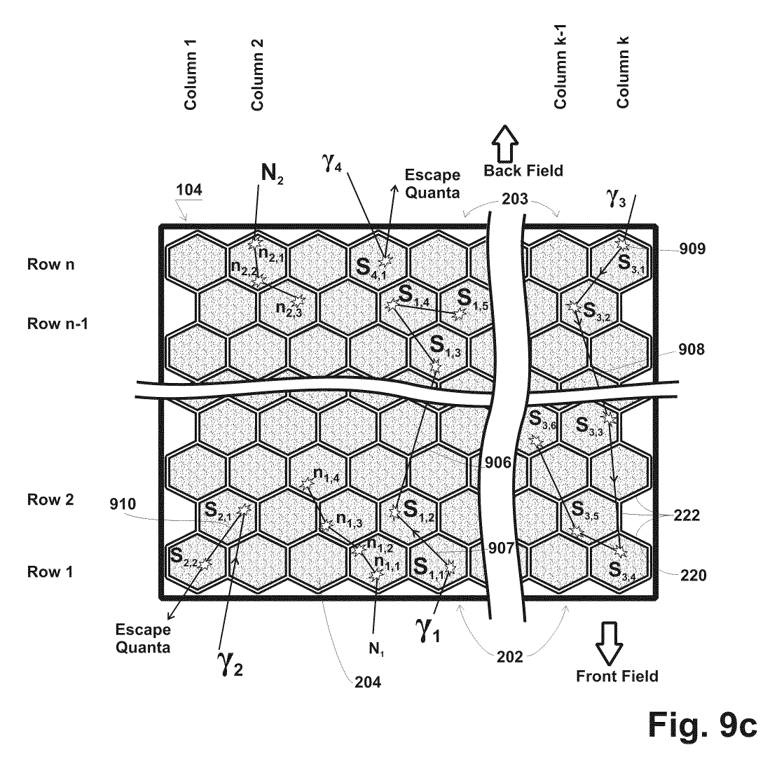

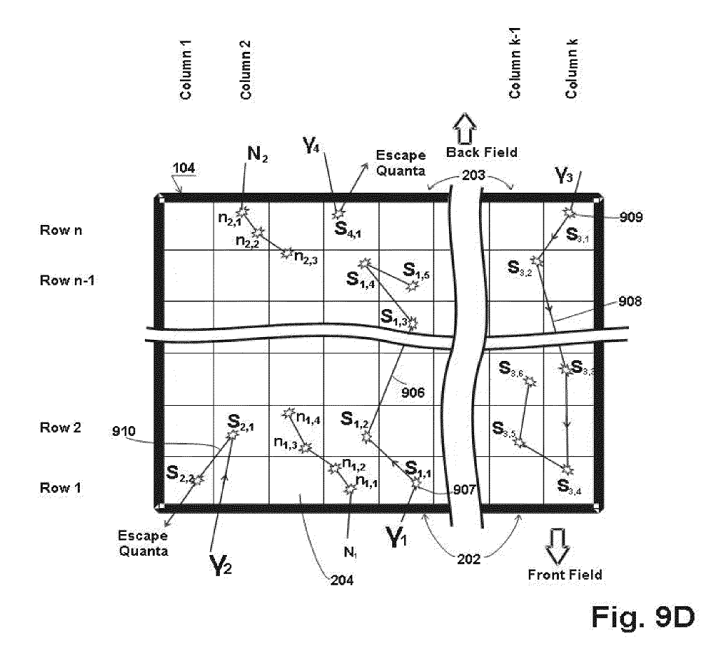

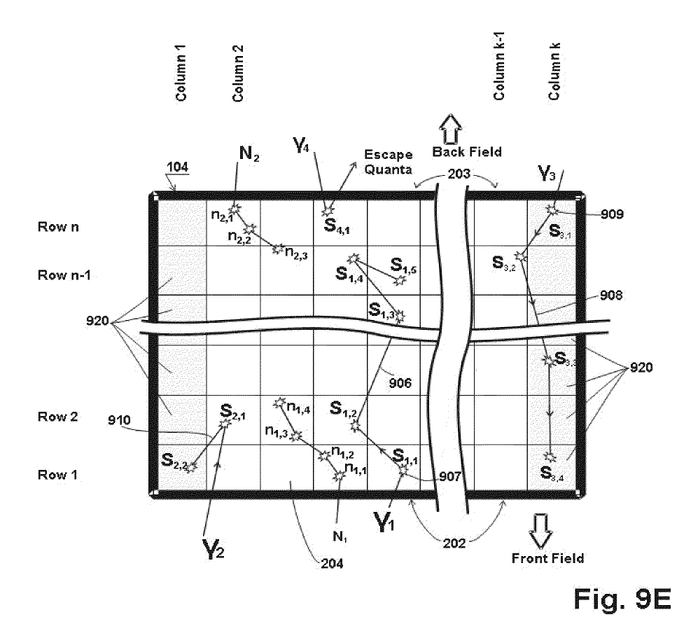

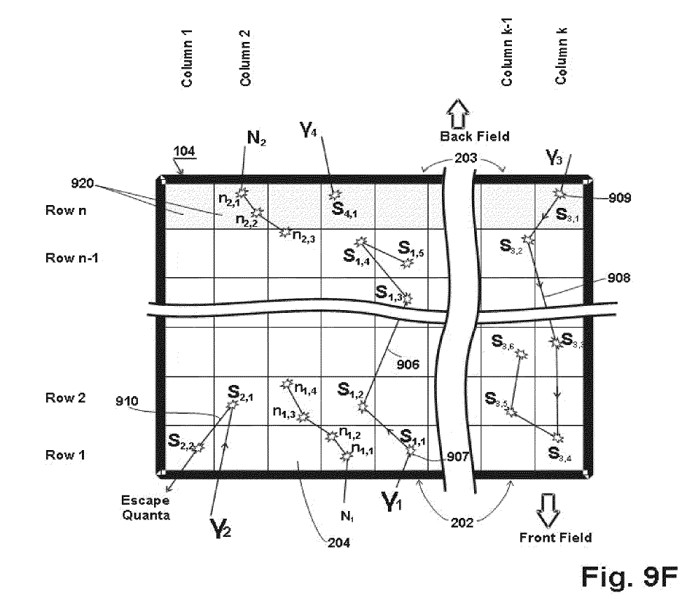

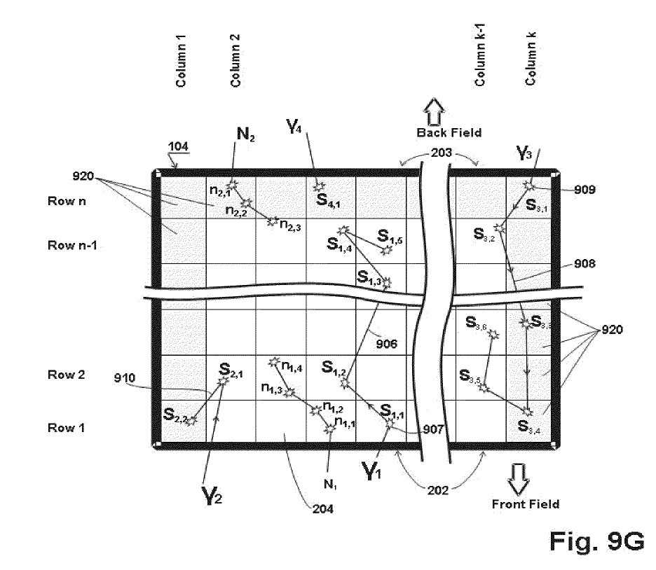

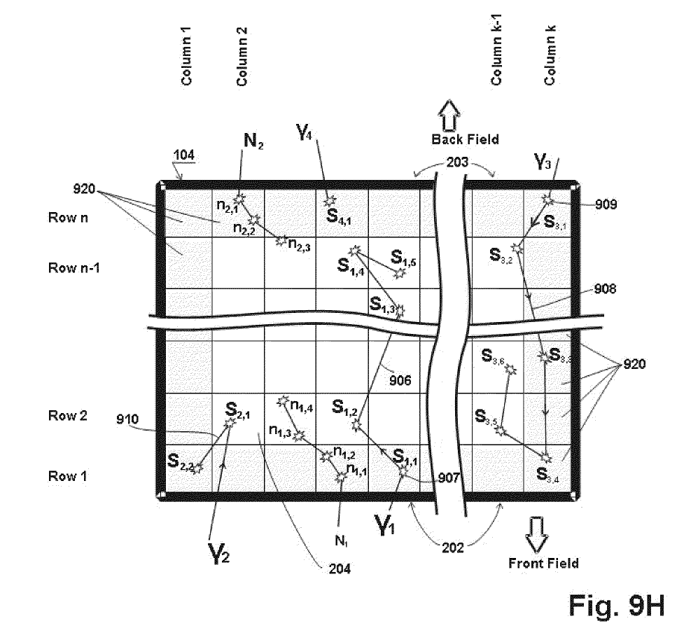

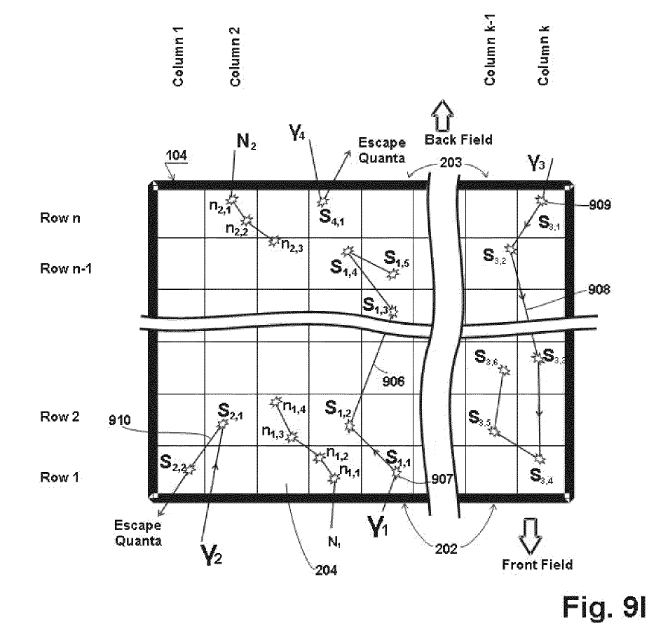

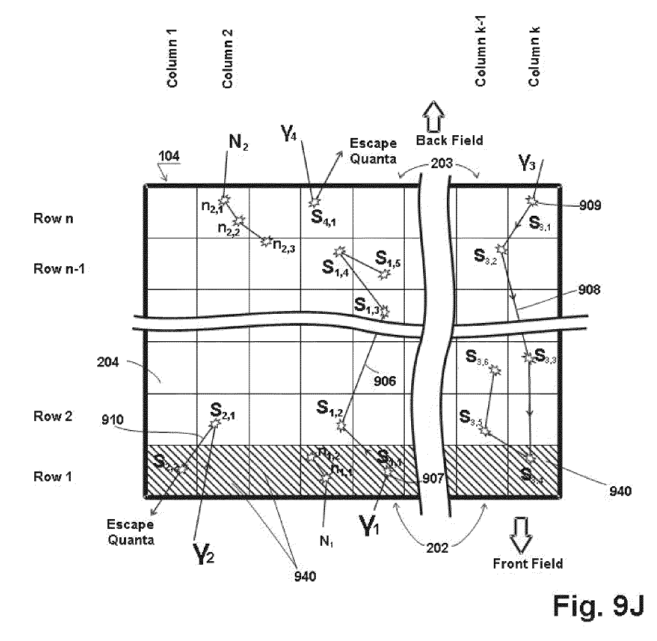

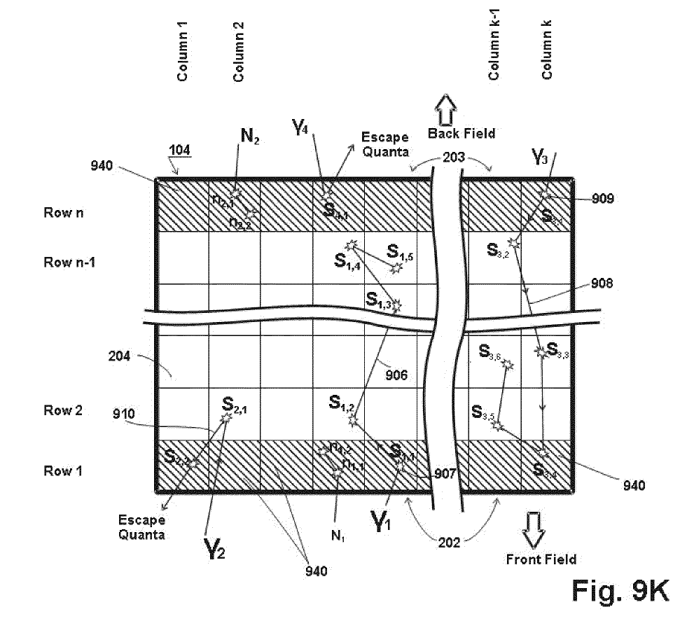

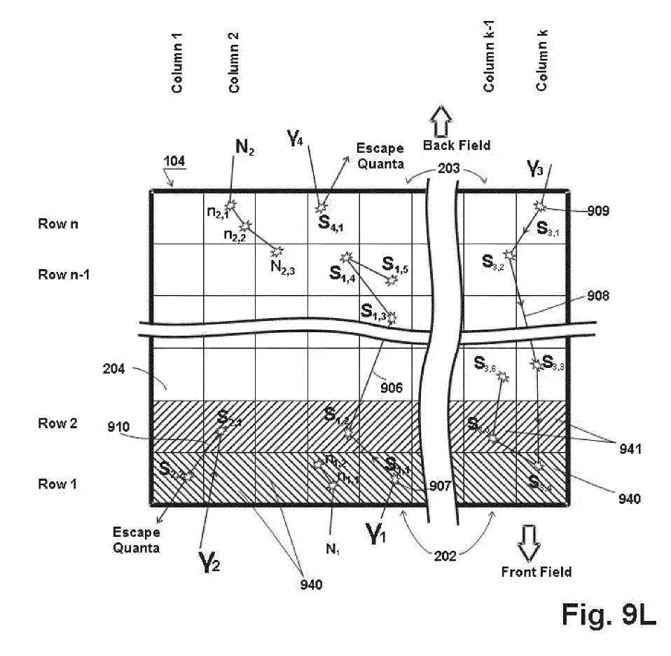

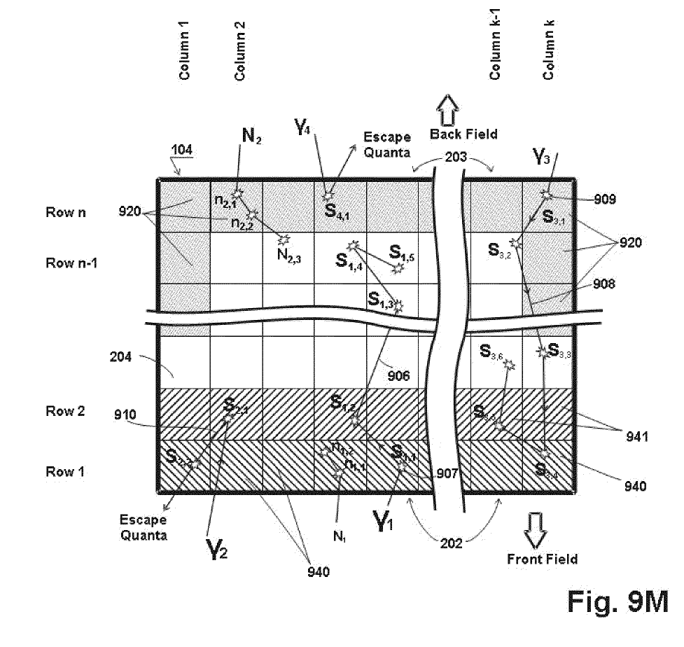

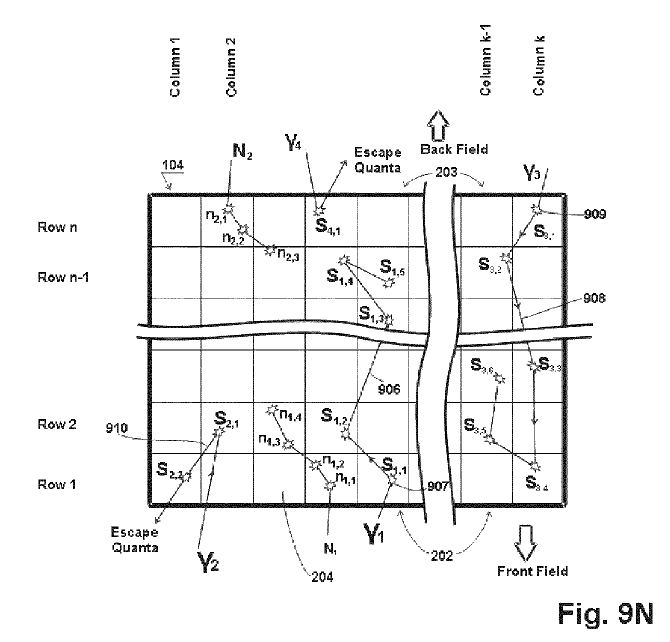

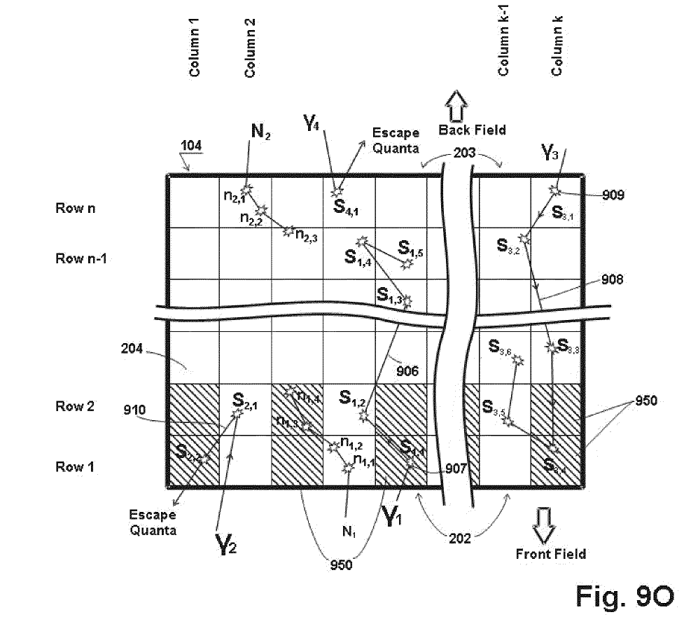

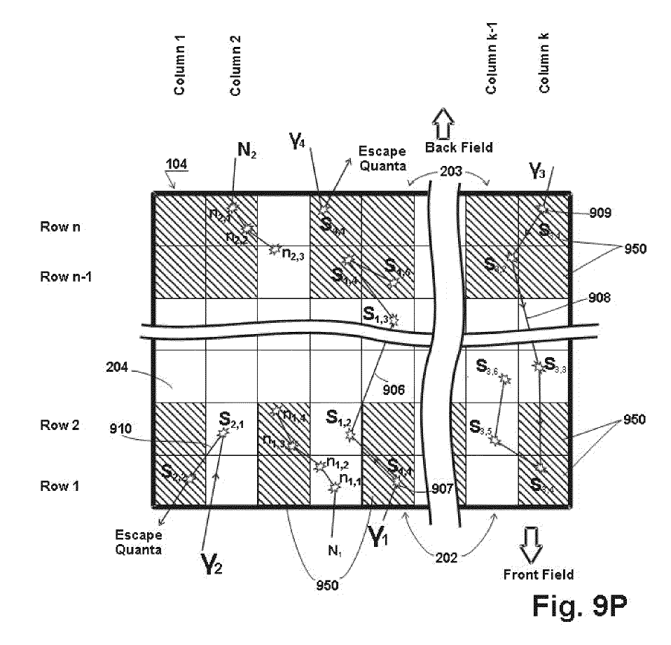

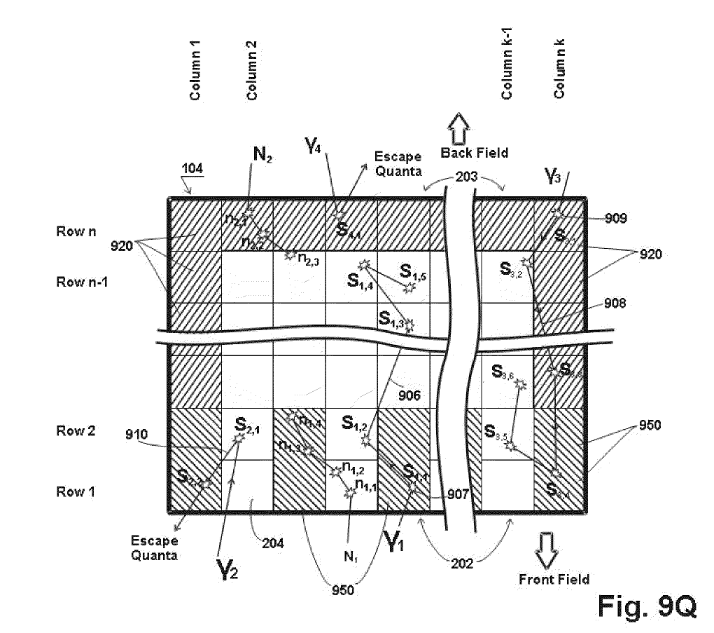

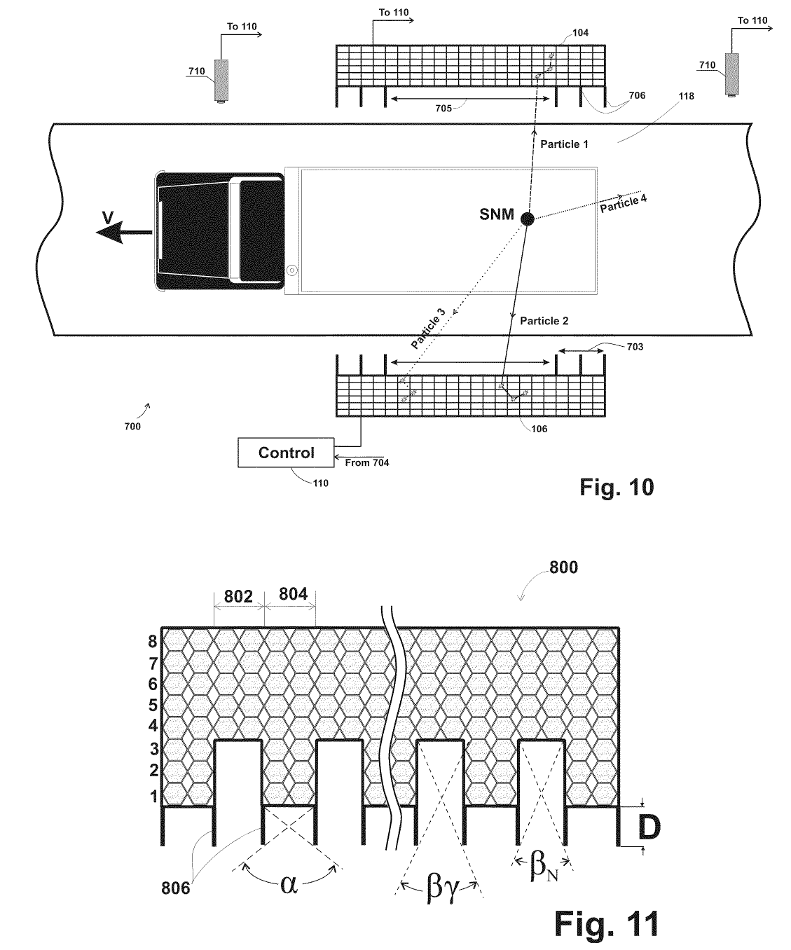

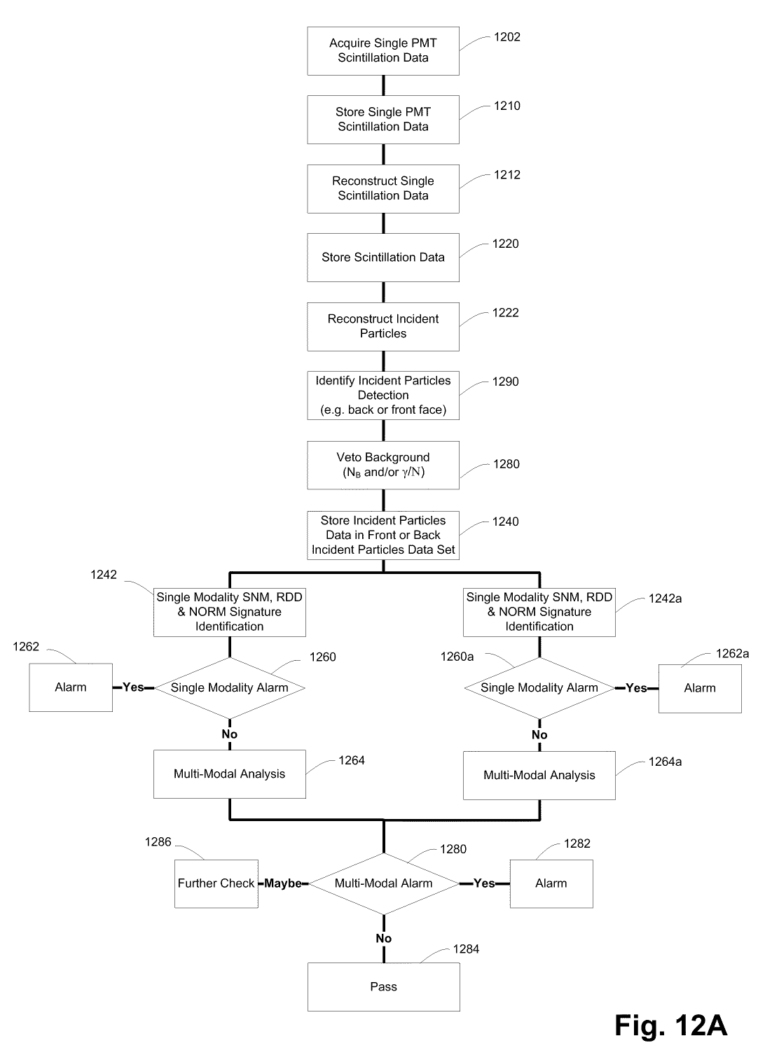

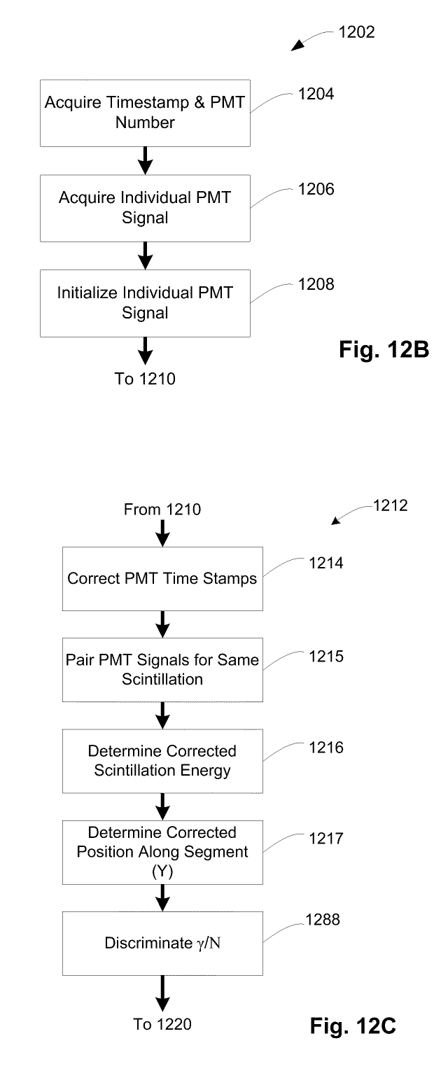

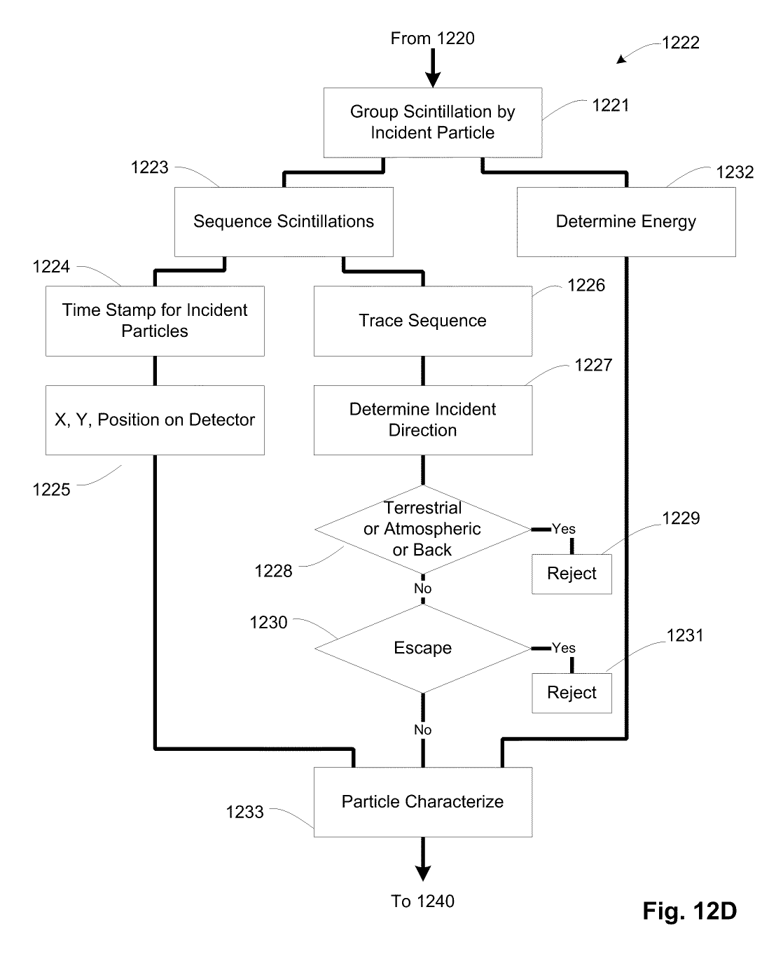

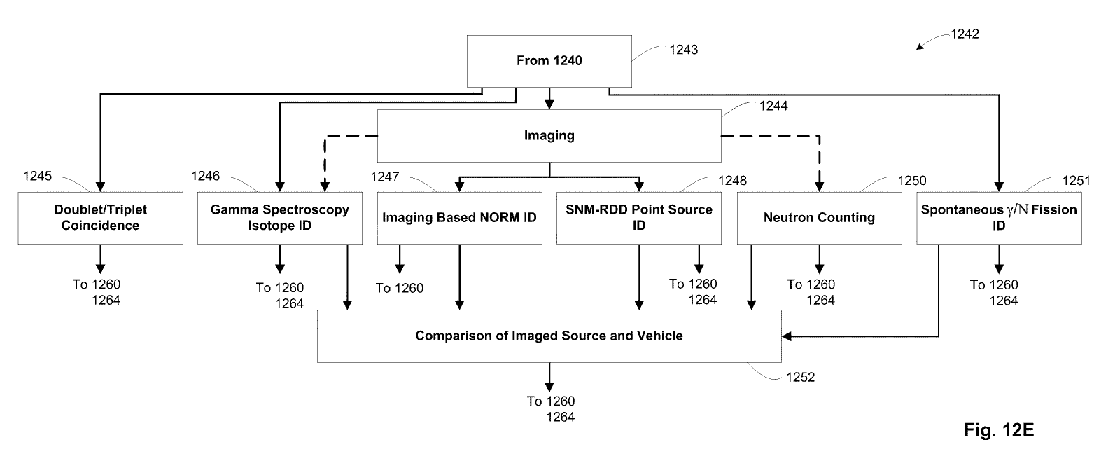

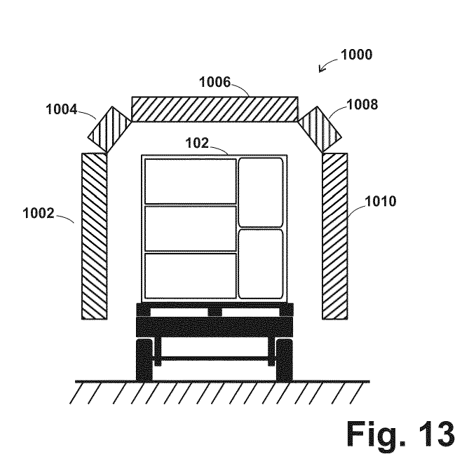

FIGS. 2A and 2B illustrate two kinds of events that occur in nuclear threat materials in accordance with an embodiment of the invention

FIG. 3 is a partial cut-away drawing of a detector assembly in accordance with an embodiment of the invention;

FIGS. 4A and 4B are plane views of two types of elongated detector segments, in accordance with an embodiment of the invention.

FIGS. 4A 4B, 4C, 4D and 4E are plane and cutaway views of five examples of polygonal elongated detector segments, in accordance with an embodiment of the invention;

FIGS. 4F, 4G and 4H are plane and cutaway views of two types of elongated detector segments, in accordance with an embodiment of the invention;

FIG. 5 is a schematic drawing similar to FIG. 1B and 1C, which also illustrates the incident gamma and neutron interactions which take place in detectors of the type described with respect to FIGS. 3, 4A and 4B in accordance with an embodiment of the invention;

FIG. 6 shows Cs-137 gamma energy spectrum comparisons between a PPO based LS detector without escape quanta veto and with escape quanta veto in accordance with an embodiment of the invention;

FIG. 7 shows U-232 (daughter) 2.6 MeV energy spectrum comparisons between a NaI(Tl) based detector and a PPO based LS detector according to an embodiment of the invention;

FIG. 8 is a schematic block diagram of exemplary front-end electronics, for use with each elongated segment of FIGS. 4A and 4B in accordance with an embodiment of the invention;;

FIGS. 9A, 9B, 9C, 9D, 9E, 9F, 9G, 9H, 9I, 9J, 9K, 9L, 9M, 9N, 9O, 9P and 9Q illustrate various embodiments of the detector bank construction including various detector rod cross sections, embodiments (in accordance with an embodiments of the invention) light reflectors, in accordance with an embodiment of the invention; rod arrangement, in accordance with an embodiment of the invention; use of high Z material loading in accordance with an embodiment of the invention; use of PSD favorable OS materials in accordance with an embodiment of the invention, the use of PSD favorable OS material at the front face while having another type of PSD effective OS at different segments in accordance with an embodiment of the invention; the use of more than one OS material to improve detector bank spatial resolution in accordance with an embodiment of the invention; and the use of more than one OS materials to reduce escape quanta in accordance with an embodiment of the invention;.

Furthermore, FIGS. 9A-9Q delineate the interactions of incident gammas and neutrons with the various segmented detector embodiments and various methods for improvement of detector bank performance (e.g. rejection of events which do not come through the front face). in accordance with an embodiment of the invention;

FIGS. 9E, 9F, 9G, and 9H illustrate various interactions of incident gammas with the segmented detector having some high Z loading materials which reduce escape quanta rate and a methodology for rejection of events which do not come through the front face.

FIG. 9I illustrates various interactions of incident gammas and neutrons with the segmented detector and a methodology for rejection of events which do not come through the front face;

FIG. 9J illustrates various interactions of incident gammas and neutrons and incorporating some segments having PSD favorable OS material 940 at the front face of the segmented detector.

FIG. 9K illustrates various interactions of incident gammas and neutrons and incorporating some segments 940 with PSD favorable OS material at the front and back faces of the segmented detector.

FIG. 9L illustrates various interactions of incident gammas and neutrons and incorporating some segments with one type of PSD favorable OS 940 material at the front face while having another type of PSD effective OS 941 at different segments.

FIG. 9M illustrates various interactions of incident gammas and neutrons and a means to fill some segments with PSD favorable OS material 940 and 941 at the front face of the detector to improve gamma-neutron identification as well as good gamma spectroscopy and high Z loaded OS segments 920 at the back of the segmented detector to reduce escape quanta fraction.

FIG. 9O illustrates a segmented scintillation detector having both low stopping power OS segmented detector interlaced with higher stopping power collimation-detection OS segments.

FIG. 9P illustrates the embodiment of FIG. 9O having additional high spatial resolution collimation-detection segments at the rear of the segmented detector.

FIG. 9Q illustrates an embodiment like the embodiment of FIG. 9O and an additional high Z loaded OS at the detector back to reduce escape quanta rate

FIG. 10 is a schematic illustration of a detection portal according to an embodiment of the invention in which a partially collimated detector is used; in accordance with an embodiment of the invention;

FIGS. 11 illustrates an alternate detector rods arrangement, in which collimation is provided, in accordance with embodiments of the invention;

FIGS. 12A-12E are simplified flow charts illustrating the methodology used to determine threats and their type, in accordance with an embodiment of the invention;

FIG. 13 shows a system in which additional detectors are used to improve capture efficiency and provide an option for transaxial tomography; and FIG. 14 shows a multi-lane system in which a same detector is used for adjoining lane in accordance with an embodiment of the invention;

FIG. 13 shows a system in which additional detectors are used to improve capture efficiency and provide an option for one dimensional or two dimensional or 3D tomography in accordance with an embodiment of the invention;

### DETAILED DESCRIPTION OF EXEMPLARY EMBODIMENTS

FIG. 1A shows a schematic drawing of a portion of a system 100 for detecting nuclear threats. As illustrated, vehicles 102, for example a screened object (e.g. a truck,) passes between two detectors 104, 106. In some embodiments only a single detector is used and in some, as described below, two or more such detectors are used. In a preferred embodiment of the invention, the detectors are of one of the types of detectors described below. The detectors are optionally high enough to cover the entire height of the truck or other objects being scanned. The length of the detector (in the direction of motion of the object) is not related to the height; however in some embodiments of the invention it is made 2, 3, 4, 6 or more meters long, so as to provide a desired detection sensitivity.

For illustration purposes, vehicle 102 is shown carrying a nuclear material 108.

A controller 110 receives signals from the detectors and based on these signals, and optionally on information regarding the speed and location of the vehicle, determines whether a possible threat is present. In the event that a threat is determined, the vehicle is either stopped for further checking or sent to additional screening stations, as described with respect to FIG. 30 of the above-referenced U.S. patent application Ser. No. 11/348,040.

FIGS. 1B and 1C illustrate system 100 in an operational mode which provides vehicle 141 having a threat 1081 to be screened concurrently with object 102. In this slow-screen mode object 1081 is either placed on the side of detector 106, for a relatively long reading time, or alternatively moves slowly (e.g. much less than 5 mph).

The controller 110 controls, in addition to its above mentioned tasks (see description of FIG. 1A), the position where the vehicle should be stationed in order to maximize detectability of a suspected region of threat 1081. This position is indicated to the system operator (or vehicle driver) by an indictor 142 which for example is a line of indication light sources which indicate to the operator (e.g. driver) where to stop the screened object (e.g. vehicle).

In another preferred embodiment of this invention an object is first screened along the lane (FIG. 1B left lane). If a suspected radiation source (e.g. point source) is detected with low certainty (e.g. <5 sigma) the object is turned around for a secondary screening. As the first screening indicates on which side of the object the radiation intensity is higher, the suspect side of the object side is positioned towards detector 106 and scanned for a much longer time by moving the object at a slow speed. For example, if screening speed is reduced by a factor of x100 the minimal detected threat activity detection level is reduced (improved) approximately by a factor of 10.

In another embodiment of this invention a gamma and/or neutron collimation 104 can improve the sensitivity by reducing benign radiation (e.g. inter-object scatter, semi-uniform NORM and ambient radiation)

FIG. 1D shows a schematic drawing of a portion of a system 100 for detecting nuclear threats. As illustrated, vehicles 102, for example a passenger car, passes between two detectors 104, 106 in a dedicated cars only lane (no trucks). Having a horizontal clearance of approximately 2 meters between the bottom detector and top detector. the advantages of this portal detector layout are

[1] The proximity of the detector to the screened object provides a better capture rate for the particles emitted by the SNM or RDD and or their radiation shield

[2] it enables a suppression of terrestrial gamma radiation emanating from the ground. This suppression is enhanced by the detector ability to identify the gross directionality of incident particles and to veto those particles that emanate from a direction other than the direction of the screened object.

[3] it enables a suppression of atmospheric neutron radiation emanating from the sky. This suppression is enhanced by the detector ability to identify the gross directionality of incident particles and to veto those particles that emanate from a direction other than the direction of the screened object.

[4] It enables the detection and identification of muons and their induced particles (not shown in the figures). It is known in the art that muons induce a relatively high rate of neutrons, x-rays and gammas when they interact with high Z materials such as Uranium, plutonium lead and tungsten. It is also known in the art that muons induce a relatively low rate of neutrons, x-rays and gammas when they interact with low Z materials such as air, and common cargo elements.

In some embodiments only a single detector is used and in some, as described below, two or more such detectors are used in a system. In a preferred embodiment of the invention, the detectors are of one of the types of detectors described below. The detectors are optionally long enough to cover the entire width of the lane or other objects being scanned. The length of the detector (in the direction of motion of the screened item) needs not relate to the lateral width; however in some embodiments of the invention it is made 2, 3, 4, 6 or more meters long, so as to provide a desired detection sensitivity.

FIG. 1E illustrates a similar preferred embodiment which is optimized for other vehicles (e.g. trucks, buses)

FIGS. 2A and 2B schematically illustrate common types of emissions that occur from nuclear threat material 108. FIG. 2A shows nuclear material (e.g. WGP) emitting both gamma rays and neutrons. The rate of emission is generally rather low and the events illustrated do not occur simultaneously, and can generally be discriminated between by the detectors 104, 106. In cases where simultaneous γ and neutrons as produced, they are generally separated in space (in different segments) so that they can be distinguished. It should be noted that some of the emitted particles are not directed toward the detectors. In addition to emissions in the forward and backward directions, emissions take place in a direction above and below the detectors, since the emission from the threat material is generally isotropic. In general the capture efficiency of any detector or set of detectors is proportional to the solid angle subtended by the detector as seen by the source of emissions, and its stopping power. Thus, the larger the detectors the greater the capture efficiency (sensitivity).

FIGS. 2C and 2D (side views of FIG. 1E) schematically illustrate common types of emissions that occur from nuclear threat material 108. FIG. 2C shows nuclear material (e.g. WGP) emitting both gamma rays and neutrons. The rate of emission is generally rather low and the events illustrated do not occur simultaneously, and can generally be discriminated between by the detectors 104, 106. In cases where simultaneous γ and neutrons as produced, they are generally separated in space (in different segments) so that they can be distinguished. It should be noted that some of the emitted particles are not directed toward the detectors. In addition to emissions in the upward and downward directions, emissions take place in a direction sideways from the detectors, since the emission from the threat material is generally isotropic. In general the capture efficiency of any detector or set of detectors is proportional to the solid angle subtended by the detector as seen by the source of emissions, and it's stopping power. Thus, the larger the detectors the greater the capture efficiency (sensitivity).

FIG. 2B shows a cascade event in which a first gamma ray is emitted in a first transition and a second gamma ray is emitted in a second emission immediately afterward. Such cascaded emissions are characteristic of some radioactive isotopes, such as Co60, and can form a very sensitive signature for recognition of such materials. These two cascaded emissions are shown as being directed to different detectors, however, in practice, there is virtually no correlation between the directions of the gamma rays and they can be directed to the same detector or more likely, only one of the events will be detected. Since the probability of detecting a single gamma event is proportional to the solid angle subtended by the detectors, the probability of detecting doublets is proportional to the square of the solid angle. Thus, the size of the detector is critical to the detection of doublets.

In a preferred embodiment of this invention the spontaneous fission signatures of SNM can be detected. The spontaneous fission of SNM emits in a sub nanosecond a plurality of neutrons and gammas. In this embodiment every detection of more than one neutron/and/or gamma at a short time window (e.g. 10-100 Nanosecond) can be considered as a signature of SNM.

In a preferred embodiment of this invention (see FIGS. 1D, 1E, 2C, 2D, 5, 10, and 13) the detector assemblies (104, 106) are placed close (preferably as close as the vertical clearance of the screened item allows) to the top and/or bottom screened item. For example, prior art ASP detection systems place their detectors on the two sides of a 5 meter lane. This results in a distance of 2.5 meters between each of the ASP's detectors and the center of the road lane. A passenger car, pickup truck or SUV-sized van and other vehicles have a height of less than 2 meters (D1). Thus placing the detectors (according to this preferred embodiment) one detector 106 below the vehicle and one 104 at a height of 2 meters (see FIG. 1D) reduces the maximum distance between a potential threat of SNM of RDD radioactive materials at 1 m. This reduces threat detectors proximity and increases the gamma and/or neutron sensitivity by the square of 2.5=6.25, a substantial increase in SNM-RDD signature detectability resulting in system ROC for single or multi-modal detection schemes,

Furthermore, as will be shown in the disclosure of this invention, the detector's ability to identify gamma and/or neutron gross directionality, background neutron atmospheric radiation Nb 101 and terrestrial gammas γb 103 can be used to veto many of those background particles. This further improves the system ROC as background radiation is reduced. FIGS. 1D, 1E, 2C, 2D, 5, 10 and 13 demonstrate the various embodiments of this preferred embodiment.

In a further embodiment a radiation gamma shield (119, FIG. 5) can further reduce terrestrial gamma background radiation.

In a preferred embodiment of this invention one detector 106 is placed below a road having a support structure 115 to carry the load of vehicles and a road pavement 117 to cover the lower detector. The other detector 104 is configured above the maximum height of the items (e.g. 2 meters for cars, SUVs, etc. D1 and approximately 4. to 5 meters high for trucks and railroad cars D2).

FIG. 3, shows a partial cut-away view of a segmented detector 200 (corresponding to detectors 104 and 106 of FIG. 1, in an embodiment of the invention). In the following discussion, the visible face of the detector is referred to as a front face 202 and the other face, as the rear face.

As shown in the exemplary embodiment of FIG. 3 and referring also to FIG. 4A, detector 200 is segmented into elongated segments of scintillation material (one of which is referenced with reference numeral 204) by reflective partitions 206. Thus, light from a scintillation which occurs in a particular segment is reflected from the partitions and remains in the same segment. By the nature of the reflections, the light is reflected toward one or the other end of the elongated segment, where it is optionally concentrated by a light concentrator before being sensed by a light detector such as a photomultiplier tube (PMT). Two light concentrators 208 and 210 and two PMTs 212 and 214 are shown on either end of the elongated scintillation material. Preferably, the scintillation material is an organic Scintillator and more preferably a liquid organic Scintillator (LS) material. Typical LS for use in the invention comprises (for a 4 m×4 m×0.5 m volume detector) a cocktail of 12 kg PPO, 6.3 m3 normal-dodecane and 1.6 m3 pseudo cumene. The barriers can be made of low Z materials. One useful material is thin nylon sheets, coated with a thin layer of reflective paints. It should be noted that the PPO Based LS cocktail mentioned above provides extremely good transparency (20 m light loss distance) and an ideal index of refraction (1.5) and a scintillation light spectrum which matches the sensitivity spectrum of Bi-Alkali photocathode. It should be also noted that the light concentrators are preferably filled with the LS.

Organic scintillators have various advantages over other scintillators, including robustness, stability and low cost, ease of manufacturing and forming, etc. Its two major deficiencies relative to the commonly used NaI(Tl) Scintillator is lower stopping power and lower scintillation efficiency of about 10.000 Photons per/Mev. Both of these deficiencies are compensated for in some embodiments of the invention.

Organic Scintillator materials are well known and have been used for simple detectors which are not used for gamma spectroscopic applications nor for imaging applications.

FIG. 4B is similar to FIG. 4A except that the segment cross section is round. It should be noted that while there are spaces between the segments when they are arranged as in FIG. 3, this does not effect operation substantially, since these spaces do not interact significantly with the gamma rays. In an embodiment of invention the individual detector segments have a cylindrical form to improve the scintillation light collection efficiency.

While the rectangular segments can be either self supported or partitions within a bath, it is believed that cylindrical segments have to be self supported.

FIG. 4C demonstrates the propagation of light along the detector segment which according to a preferred embodiment of this invention uses specular light reflector placed around the scintillator.

FIG. 4d is similar to FIG. 4A except that the segment cross section is a six sided polygon. In a preferred embodiment of this invention the individual detector segments have a six sided polygon form to improve the scintillation light collection efficiency, and/or reduce transverse light collection efficiency variations and/or improve the partitioning mechanical design flexibility and/or strength

FIG. 4E is similar to FIG. 4A except that the segment cross section is an eight sided polygon. In a preferred embodiment of this invention the individual detector segments have an eight sided polygon form to improve the scintillation light collection efficiency, and/or reduce transverse light collection efficiency variations and/or improve the partitioning mechanical design flexibility and/or strength

Alternatively or additionally, the detector segments can have other various geometric forms of cross sections [e.g. triangle. Ellipse, rhombic Crosse sections]

Alternatively or additionally, the detector segments can have more than one geometric cross sections form [e.g. rectangular and triangle Crosse sections,]

Alternatively or additionally, the segments are spaced from each other. In a preferred embodiment of this invention the this spacing is used to improve the identification (augmented with PSD gamma neutron identification) of neutrons (which have a slower velocity than gammas) from gammas by using the temporal signature of multi scintillations of an incident particle.

In a preferred embodiment of this invention the light collection efficiency of individual segments is improved (see FIGS. 4F, 4G and cutaway CC, cutaway AA and cutaway BB) by optically coupling a light transparent segmentation layer 222. According to this preferred embodiment of this invention the index of refraction of the segmentation layer 222 is higher than the index of refraction of the scintillation material 220. The remote side of the segmentation layer (the side which is remote from the scintillator) is covered (e.g. painted) with a light reflecting coating 220 (e.g. reflective paint). Several materials can be used for the high index of refraction segmentation layer 222 such as Mylar and high index of refraction glass. As shown in the cutaway, a scintillation 224 which emits light isotropically will have some of its light reflected 227 due to the reflection of the interface between the scintillator 204 and segmentation layer 222. and will be piped, via the scintillation media, to the photo detectors. The rest of the light will pass through the transparent layer 222 at sub-critical angle and will then be reflected (e.g. diffuse reflection 225) by the reflective coating 220. FIGS. 9A and 9B illustrate how within the high index of refraction segmentation layers 222 a reflecting layer 220 is either “sandwiched” as in FIG. 9A or not “sandwiched” as in FIG. 9B.

If solid OS segments are used, then the construction is simpler and all that is need is to form the segments and cover them with light reflecting means.

When a scintillation takes place, the light generated is emitted in all directions. Thus, some of the light travels toward one end and is detected by one of the PMTs and some travels in the other direction and is detected up by the other PMT. Any light photons that are not directly aimed along the elongated segment, will reflect off the reflective walls, possibly multiple times and arrive at the end with a slight delay compared to the directly aimed photons. Since the velocity of light in the scintillation medium is known, the time difference between the ‘leading edge’ of the light signal by the two PMTs is indicative of the position of the interaction along the length of the segment. This method is known in the art as Time of Flight (TOF) localization. In addition since there is some path length dependent attenuation of the light as it travels through the scintillator material, the amplitude of the light is different at the two ends if the scintillation does not occur at the exact midpoint. In an embodiment of the invention one or both of the TOF and amplitude ratio are used to determine the position of the scintillation along elongated segment 204.

Since both time differences and amplitude ratio are affected by other factors, the segments are preferably calibrated using a procedure described below.

As was shown in the incorporated regular U.S. patent application Ser. No. 11/348,040, with respect to FIGS. 27-29, elongated detectors can be used as threat detectors with one dimensional position discrimination. As can be seen from FIG. 3 of the present application, segments 204 are stacked vertically. Thus, each such stack will provide information as to position of a scintillation occurring at its depth in both the vertical and horizontal directions, i.e., two-dimensional position detection. It is noted that the depth of the detector does not by itself provide a 3D image.

Scintillation materials of the preferred type detect both neutrons and gamma rays. However, the footprints of scintillations that are produced are different. In both cases, the energy of the incoming radiation is given up via a series of interactions, which result in scintillations. However, the distance between such events is different, being substantially longer for the gamma rays than for neutrons of typical energies. In an embodiment of the invention, the depth and height of the segments is such that, in many cases, a single scintillation takes place in a particular segment for gamma rays and multiple interactions, even most of the interactions, take place in a same segment for neutrons of energies that are expected from fissile materials.

Another difference is the scintillation rate of decay for the two types of interactions, especially when all the scintillations caused by an incoming event is considered. This phenomenon is well known and has been used to discriminate between gamma rays and neutrons in non-imaging detectors using PSD methods.

In threat detectors the rate of incoming events is generally low at rates of a few thousand counts per second per meter2. At such low rates, the probability that two scintillations from different incident gamma events will take place in a nearby location at the same time window is low, hence each incident particle and its associated scintillations can be analyzed individually. If the signals produced by the PMTs are time stamped and digitized, then scintillations in different segments can be correlated and the positions of a series of scintillations caused by a single incident particle can be correlated. The utility of this information will be described below.

In the preferred embodiment of the invention, the partitions are substantially transparent to gamma rays and other quanta such as higher energy electrons, neutrons and protons. Thus, while light is trapped within a particular segment, residual energy, in the form of a gamma ray, or other quanta, not converted to light (or heat) in a particular interaction can pass through the partition into a neighboring (or farther) segment.

In an exemplary embodiment detector 200 comprises a plurality of layers of segments, arranged in the direction perpendicular to front face 202, as shown in FIG. 3. Thus, an incoming incident gamma event will cause a series of scintillations as it interacts with the detector. Often, depending on the incident gamma energy, each scintillation takes place in a different segment.

FIG. 5, is similar to FIG. 1 except that gamma and neutron events and the train of scintillations they cause are shown.

In a preferred embodiment of this invention both front side and rear side of detector 108 are used to screen two items concurrently, preferably at different screening speeds. Note that the gamma/neutrons emitted by source 108 and 1081 can be discriminated due to their spatio-temporal signature in the segmented detector 106.

As shown in FIG. 5, nuclear materials 108 and 1081 emit both gamma and neutrons particles. The neutrons cause a series of scintillations, generally in one segment. These scintillations are treated as a single scintillation. This series of scintillations can be identified as being generated by a fast neutron, from a characteristic pulse shape measured by PMTs 212 and 214 (FIGS. 3 and 4). It is noted that a further large scintillation at 2.2 MeV caused by the thermalized (slowed down) neutron capturing on Hydrogen may optionally be considered as an additional correlation, although the time delay for that secondary event is longer and randomly variable. Incoming gamma rays generate a more complex pattern of scintillations. As indicated above, the mean distance between scintillations could be large as compared with the cross-sectional dimensions of segments 204. Thus, some gamma event causes a series of distinct scintillations as it moves through the detector and gives up energy. One such series is indicated by reference numerals 502, 504 and 506.

A statistical most probable incoming direction of the event can be calculated. This direction is only a gross direction and is generally not sufficiently good for imaging. However, it does enable substantial rejection of background radiation such as terrestrial and atmospheric radiation. This is based on the fact that the direction of the gamma particle having the residual energy after Compton an interaction is related to the incoming direction. Generally, the most probably incoming direction is a straight line between the first and second scintillations.

It should be noted that since detector 200 collects light from all of the scintillations caused by the incident gamma rays, the light collected by scintillator 204 can be used for spectroscopic isotope identification. The spectral resolution depends on a number of factors, some of which are correctable. One of these is a systematic variation in light collection efficiency as a function of position of the scintillation within a segment. In general, the main variable in this respect is the distance and average number of reflections that light from a scintillation event has to undergo in order to reach each of the photomultiplier tubes. This can be calculated (or measured for a typical segment, as described below) and an appropriate correction made to the energy signal (integral of the light received) indicated at the front-end electronics or system software, based on the determined scintillation position along the segment.

Other correctable variations are gain and delay variations among the individual PMTs. These can also be determined as part of an overall calibration for the segment.

In an experimental calibration of loci dependent light collection efficiency variation correction, according to an embodiment of the invention, a point source of mono-energetic gamma rays or high energy mono-energetic betas is placed adjacent to an individual segment and the energy signals provided by the sum of the two PMTs is measured. This is repeated for a number of positions along the length of the segment. Interactions between the OS material in the segment and the ray will cause scintillations. The signals generated by these scintillations in the PMTs at the end of the segments can be used to define a ratio of signals and a time delay between signals as a function of actual position along the segment.

For betas, the entire energy is transferred in a single interaction. However, for gamma, the energy transferred in the interactions (and the energy in the scintillations) is variable. However, the peak energy scintillations can be assumed to be the result of a direct photoelectric effect interaction (or otherwise a full energy deposition within the segment) and thus their energy is known (i.e., it is the energy of the incoming gamma). This known energy and position can be used as a standard for generating a position dependent energy correction table.

This measurement is repeated for all of the segments and used to provide a look-up table of corrections which enable the conversion of pairs of time-stamped light signals into energy signals and position values, which are used in the method described in FIG. 12.

Alternatively, the energy collection efficiency can be assumed to be the same for all the segments. Similarly, the collection efficiency as a function of position along the segment can also be assumed to be the same for all segments. Thus, measurements of energy signal correction factors can be approximated for all of the segments, by measurements on a single segment. Such approximation can be expected to give poorer spectral results than when energy correction is based on individual measurements of each detector.

Alternatively, the absolute energy sensitivity of the individual segments is measured, and the spatial distribution is assumed to be the same for all segments. In order to do this, an energy measurement, as described above is performed, but only for a single point along the length of the segment. The sum of the values of the signals is compared to a standard and the energy efficiency of collection is determined by the ratio of the signals. Optionally, the standard is based on measurements of a number of segments. It is noted that this alternative also gives a time difference between the detectors on both ends of the segment.

However, neither this nor the other alternative methods of energy signal calibration allow for determination of an absolute time delay, which is used for some embodiments of the invention.

Absolute time delay (and a correction for such delay variations) for each PMT channel can be determined by feeding a light signal that simulates a scintillation into the segment and then measuring the time delays of the signals outputted by each of the two PMTs at the ends of the segment. If the signal is fed into center of the segment for all of the segments, the time delays of all of the PMTs channels for all the segments can be determined so that a comparison of the times of the signals from each PMT can be used to provide a consistent time stamp for each scintillation event.

It is noted that the segments partitions are coated by a light reflecting material. In order to feed light into the segment, a very small portion of the segment is left uncoated at the center of the segment. Optionally, an LED is embedded in the segment wall and the delay testing is performed on the segments in the assembled detector. These measurements can be performed periodically to partially compensate for instability or drift of the PMTs.

Optionally, alternatively or additionally, the PMTs and their associated circuitry are calibrated before assembly by feeding a light impulse of a standard intensity and timing into the PMT. The output of the circuitry is then measured and the gain and delay is noted and used to determine a correction factor for both energy measurement and timing. Optionally, the circuitry is adjusted to change the gain and time delay such that the outputs of all the PMTs have the same integrated signal output and timestamps.

Optionally, the PMTs can be removed from the rest of the segments so that they can be replaced, or adjusted when they go out of the calibration range.

If the segments are not separable (e.g., they are in a bath) other methods can be used to determine energy and time delay corrections. In this case a collimated beam of high energy gammas (e.g., 1.4 MeV of K-40) is introduced perpendicular to the face of the detector. This beam has a substantial half length in the LS, before the first interaction and some of the interactions will be photoelectric interactions. The energy of these interactions is known and the difference in signals produced in the various segments (also as a function of position along the segments) is used to calibrate for energy. It can also be used to calibrate for position determination using signal strength, using the ratio of signals when the beam is at the center of the section as a standard correction for the ratios produced during detection of threats. This measurement can also define a relative difference in delay between the two end PMTs which can be used to determine the y position correction. As to absolute timing, this can be determined to a reasonable accuracy by the use of LEDs situated near each of the PMTs.

An additional source of reduction in gamma spectroscopic isotope ID quality is caused by energy that is lost when a residual gamma or electron escapes from the detector. While this phenomenon is well known, correcting for it is difficult, since it can not be determined on an individual basis if such escape occurred and also how much energy escaped. The result will be that the spectrum of an monoenergetic gamma source will have a lower energy pedestal as seen in FIGS. 6 and 7. It has been found that in general most incoming gamma rays of a given energy have a certain range of number of scintillations before they give up all their energy. If events that have below this number of scintillation are rejected, then the spectrum is substantially improved, at the expense of some loss of events. This phenomenon is shown graphically in FIG. 6. that shows the results of two Monte Carlo simulations, one without and one with escape quanta veto. The first simulation (represented by the upper spectrum) is a straight forward single energy gamma spectrum. Note that the escape quanta result in a lower energy pedestal on the left side of the peak. This phenomenon impairs the detectability of lower energy peaks. The same simulation was repeated. This time the total number of scintillations was counted for each incident gamma particle. Individual incident gammas which resulted in less than a threshold number of scintillations have been rejected (vetoed). Note the disappearance of a low energy pedestal in the second simulation and the reduction of peak sensitivity.

FIG. 7 shows normalized 2.6 Mev gamma energy spectrum comparisons between an NaI(Tl) detector and a detector of the type described above.

FIG. 8 is a schematic block diagram of exemplary front end electronics 600, for use with each elongated segments of FIGS. 4A and 4B. It is noted that the circuitry is symmetrical about the 5 center of the center of the drawing. Only the upper half of the drawing is discussed.

The upper signal line represents circuitry 602 for gain stabilization PMT voltage division and outputting 604 of signals from the upper PMT anode (PM2). This signal is fed to a snap-off timing discriminator 606 and a delay circuit or delay line 608, typically 15 nsec long. It is also fed to an adder 610. The snap-off timing discriminator and timestamp circuitry are used to provide a timestamp representing the time of the leading edge of the signal. This value is saved to be used in the analysis described below with respect to FIG. 12. The signals fed to the fast amplifier by the PMTs are added to provide a crude energy signal for the scintillation. The amplitude of this gives a rough measure of the amplitude of the signals in a scintillation range ID circuit, 616. This measure is used to set a variable gain amplifier 612 with an appropriate gain, before the signal from the PMT has passed delay circuit 608. An 8 bit flash ADC (614) is used to digitize the signal, preferably with a sampling rate of 1-2 nsec. The digitized signal (and its companion from the other PMT) is stored together with the time stamp. Thus for each PMT, an uncorrected intensity and timestamp are stored. The use of these stored values is described in conjunction with FIG. 12. The circuits shown between the upper and lower lines could be replaced by a pair of 14 bit flash ADCs. However, the circuit shown is substantially less expensive.

FIG. 9A illustrates a methodology for rejection of events which do not come through the front face of the detector, or alternatively for identifying and separating between the events that come through the front or rear faces. As was indicated above, it is possible to determine a statistically probable direction of incidence of a gamma ray. FIG. 9A further illustrates this method. Detector 104, having a front face 202 and a back face 203 is shown with tracks 906, 908, 910 of scintillations caused by three incident gamma rays.

While the probable direction of incidence of gammas associated with tracks 906 and 908 can only be estimated statistically, it is practically certain that the gamma ray that resulted in track 906 is incident from the front of the detector and that associated with track 908 is incident from the back of the detector. This is true for two reasons. First, the initial scintillation 907 of track 906 is nearer the front than the back face and the initial scintillation 909 of track 908 is nearer the back face. This provides a certain probability (depending on the mean free path of the gamma ray and the thickness of the detector) that the track resulting in 906 is caused by an incident ray passing through the front and the track resulting in 908 is caused by a ray passing through the back face. Thus, the sequence of scintillations or each track provides an indication of rear or front entry of the event.

In addition, the direction determined from the initial path of the track shows a high probability of incidence from the front for track 906 and from the back for 908.

In embodiment of the invention, one or both of these factors (nearness and probable direction) are utilized to separate between gamma rays that enter from the front and those that enter from the back.

Track 910 corresponds to a gamma ray that has a much lower number of scintillations than normal. This is preferably classified as an event that for which not all the energy is captured. Such scintillations are preferably ignored.

In a preferred embodiment of this invention some of the elongated detector rods use high Z material loading placed at specific locations (e.g. the back side) to reduce the quantity of escape quanta from the periphery of the segmented detector.

FIG. 9E illustrates a methodology of reducing the quantity of escape quanta from the periphery of the segmented detector. This is achieved by using higher Z material (e.g. lead loaded OS) loading of the OS in the side Columns 1 and K of the segmented detector while having unloaded OS segments in Column 2 through Column K-1. This preferred embodiment reduces the rate of escape quanta by improved capture of the particles in Columns 1 and K [see FIG. 9E]. The penalty for this embodiment is a reduced light yield of scintillations occurring in the high Z loaded segments. For example γ2 which had an escape quanta in FIG. 9D has a higher probability of being captured by the high Z loaded OS cell 1,1 by photoelectric interaction S2,1.

FIG. 9F demonstrates another preferred embodiment of this invention to reduce escape by loading the OS in at least one row (Row N, FIG. 9F) with high Z material (e.g. lead). For example γ4 which has an escape in FIG. 9D will be probably captured by the high Z loading (see S4,1).

FIG. 9G another preferred embodiment of this invention combines the merits shown in FIG. 9E and 9F by surrounding the non-loaded segmented cone by higher Z loaded cells on 3 sides of the segmented detector.

FIG. 9H another preferred embodiment of this invention shows a 4 sided high Z loading which reduces escapes from peripheral segments. #21

In a preferred embodiment of this invention some of the elongated detector rods use OS loading (e.g gadolinium) placed at specific locations (e.g. the front side) to improve the detection of neutrons

FIG. 9J illustrates a segmented detector which improves the discrimination of neutrons from gammas. In contrast to FIG. 9I which uses one type of OS, in FIG. 9J some front face segments include OS material (e.g. BC-519, BC-454) 940 which favors a more effective PSD process than the OS (e.g. the PPO cocktail) which favors good gamma spectroscopy. 9J illustrates various interactions of incident gammas and neutrons and incorporating some segments having PSD favorable OS material 940 at the front face of the segmented detector.

FIG. 9K illustrates an embodiment similar to the one described in FIG. 9J in which both some front and back row segments include PSD gamma-neutron discrimination while the rest of the segments include OS which favor gamma spectroscopy. FIG. 9K also illustrates various interactions of incident gammas and neutrons and incorporating some segments 940 with PSD favorable OS material at the front and back faces of the segmented detector.

FIG. 9L uses more than one type of PSD favoring OS which balances the system neutron discrimination vs. gamma spectroscopy performance. FIG. 9L illustrates various interactions of incident gammas and neutrons and incorporating some segments with one type of PSD favorable OS 940 material at the front face while having another type of PSD effective OS 941 at different segments.

FIG. 9M uses the configuration of FIG. 9L in which some back side segments include high Z loaded OS to further reduce escape quanta. FIG. 9M illustrates various interactions of incident gammas and neutrons and a means to fill some segments with PSD favorable OS material 940 and 941 at the front face of the detector to improve gamma-neutron identification as well as good gamma spectroscopy and high Z loaded OS segments 920 at the back of the segmented detector to reduce escape quanta fraction.

FIG. 9N illustrates a methodology for rejection of events which do not come through the front face of the detector, or alternatively for identifying and separating between the events that come through the front or rear faces. As was indicated above, it is possible to determine a statistically probable direction of incidence of a gamma ray. FIG. 9A further illustrates this method. Detector 104, having a front face 202 and a back face 203 is shown with tracks 906, 908, 910 of scintillations caused by three incident gamma rays.

While the probable direction of incidence of gammas associated with tracks 906 and 908 can only be estimated statistically, it is practically certain that the gamma ray that resulted in track 906 is incident from the front of the detector and that associated with track 908 is incident from the back of the detector. This is true for two reasons. First, the initial scintillation 907 of track 906 is nearer the front than the back face and the initial scintillation 909 of track 908 is nearer the back face. This provides a certain probability (depending on the mean free path of the gamma ray and the thickness of the detector) that the track resulting in 906 is caused by an incident ray passing through the front and the track resulting in 908 is caused by a ray passing through the back face. Thus, the sequence of scintillations or each track provides an indication of rear or front entry of the event.

In addition, the direction determined from the initial path of the track shows a high probability of incidence from the front for track 906 and from the back for 908.

In embodiment of the invention, one or both of these factors (nearness and probable direction) are utilized to separate between gamma rays that enter from the front and those that enter from the back.

In a preferred embodiment of this invention some of the elongated detector rods use high z material loading placed at specific locations’ to create gamma collimation of the segmented detector.

In a preferred embodiment of this invention the segmented OS detector acts as a self-collimated detector without the known downside of collimation the reduction of detection sensitivity. As point source detectability is proportional to sensitivity/spatial resolution squared, it is advantageous to improve spatial resolution without sacrificing sensitivity which is common problem in traditional radionuclide collimators.

FIG. 9O illustrates one of the various embodiments possible according to the present invention. All segments apart from (marked) segments in Row 1 and 2 on the odd columns (e.g. 1, 3, 5) are based on one type of OS while the others segments 950 (marked in FIG. 9O) Row 1 and 2 in the odd columns have a high absorption coefficient for gammas. This is done by using high Z loading (e.g. lead loaded LS) for those so-called collimation segments 950. Incident γ particles that interact for the first time with even columns will have some collimation due to the collimation segments 950 will be counted without sensitivity loss. For “neutron collimation” imaging the (marked) collimation segments 950 will have to be loaded with high neutron cross section material.

FIG. 9P shows back and front collimation having low spatial resolution at the front field and a high spatial resolution at the back field

FIG. 9Q has a front face collimation with back part segments having high Z loaded OS aimed at reducing the escape quanta rate.

FIG. 10 is a schematic illustration of a detection station 700 according to an embodiment of the invention in which a pair of partially collimated detectors 702, 704 is used. As was indicated above, it is not possible, based on the detected scintillations alone, to accurately determine the direction of incidence of gammas, let alone neutrons, except for determining the detector side in which neutrons interacted.

Detectors 702 and 704 have a portion 703 of the detector that is collimated by High Z collimator plates 706 and a portion 705 that has no collimators. In an embodiment of the invention the collimated portion is used for detection and imaging of gammas and the uncollimated portion is used for detection of gammas. The entire detector is used for the detection of neutrons, without imaging.

Also shown on FIG. 10 is a pair of CCTV cameras 710. These cameras are one example of how the velocity and position of the vehicle is determined and allow for the construction of a composite image based on scintillations detected over the entire time that the vehicle travels between the detectors in a coordinate system that moves with the vehicle. In addition, by correlating the detected gamma and neutron images determined from the detectors with the optical images from a CCTV camera or camera, the position of the suspected threat within the vehicle can be estimated and used to better access the probability of threat. As described in U.S. patent application Ser. No. 11/348,040, this can improve the system ROC.

In a preferred embodiment of this invention another object is screened facing the back side of detector 702 and/or 704. This requires another set of CCTV cameras 710 facing the one (or two) adjacent lane(s). Furthermore a collimator can be mounted (not shown) at the rear of the detectors 702 and/or 704 to improve spatial resolution.

FIG. 11 illustrates an alternative detector 800, in which collimation is provided, in accordance with embodiments of the invention.

Detector 800 is characterized by having a different depth over different portions of the detector. This detector is meant to provide a trade-off between sensitivity and spatial resolution as 5 well as between spatial and energy resolution. This corresponds to a trade-off between image based threat detection quality and other signatures detection quality.

Consider first section 802, which has less depth. However, the front face of this section is bounded by adjoining sections 804. Sections 804 act as collimators for section 802, since they absorb gamma rays and neutrons that do not arrive via angle β_{N}. Thus, for sections 802, the direction of captured neutrons in the direction shown is limited. For gammas the angle is smaller, and is reduced by optional collimator plates 806 to an angle β_{γ}. Furthermore, collimators plates can be placed inside the cavities in the detector, parallel to the plane of the drawing. This will similarly limit the angle in the other direction for the gammas. Optionally, neutron absorbing OS material can be used instead of high z collimators to provide a measure of collimation in the other direction for neutrons.

Now consider the second section 804; this section will have a lesser directivity α for gammas (and only gross directivity for neutrons), but, since the detector is deeper at this point, will have generally better energy selectivity for gamma rays. This is based on the expectation that more of the energy will be captured by making the detector thicker. α, β_{γ} and β_{N} are typically of the order of 4, 1.2 and 2 meters, FWHM at a distance of two meters. It is understood that these values are a balance between image spatial resolution, particle capture efficiency and to a lesser degree, spectral selectivity (based mainly on a reduction of capture efficiency).

FIGS. 12A-12E are simplified flow charts illustrating the methodology used to determine threats and their type, in accordance with an embodiment of the invention.

FIG. 12A is an overall, simplified flow chart of a method 1200. In the illustrated method, a plurality of signals from each PMT 212 is acquired, for example, using the circuitry of FIG. 8. This acquisition is explained more fully below with reference to FIG. 12B. The individual PMT data is stored (1210) and signals are corrected and paired (1212) to reconstruct the characteristics of each scintillation event. This process is described more fully with respect to FIG. 12C. Data for each scintillation is stored (1220).

The stored data is grouped by incident particles which are reconstructed and individually analyzed (1222). This process is described more fully with the aid of FIG. 12D. The individual particle data is then stored (1240).

In a preferred embodiment of this invention the individual incident particles are stored in separate back incident particles and front incident particles data sets. This provides the ability to process the radiation of both a back and front panel screened object independently. If and when the two items are screened simultaneously they will be processed individually by 1242, 1260, 1262, 1280, 1286, 1282, & 1284 or 1242a, 1260a, 1262a, 1280a, 1286a, 1282a, & 1284a.

The incident particle data is analyzed to determine one or more “signatures” (1242) characteristic of SNM, RDD and NORM and/or their isotopes. This is discussed more fully with respect to FIG. 12E.

Based on the individual signatures, a determination is as to whether a threat is present (1260). If a threat is identified with a high probability (e.g. >5σ), then an alarm is generated (1262). If multimodal analysis is available, then such analysis (1264), as described further below, is performed. If it is not available, then 1260, 1262 are replaced by 1280, 1282, 1284 and 1286, described immediately below. It should be noted that if multi-modal analysis is available, then it is usually performed before any alarm is sounded to verify the single modality determination and to reduce false alarms.

After multi-modal analysis, (and more preferably a plurality of multi-mode analyses) a threat assessment (1280) is performed. If the multimodal threat probability is above a certain threshold, then an alarm is generated (1282), If it is below a second, lower threshold, then the vehicle/object being tested is cleared (1284). If it is between the two thresholds, then the vehicle/package is sent for further manual or machine testing (1286).

Returning to 1202, reference is made to FIG. 12B, which is a simplified flow chart of the processes of single PMT signal acquisition. At 1204 the signal is identified as a signal and given a time stamp. The signal is acquired (1206) and digitized (1208). In an embodiment of the invention, the circuitry of FIG. 8 is used to acquire the signals.

Returning to 1212, reference is made to FIG. 12C, which is a simplified block diagram of the process of reconstructing the characteristics of individual scintillations from the separate signals of the PMTs. The data in the PMT raw database is corrected in accordance with the correction factors described above. The time stamp is corrected (1214) for each scintillation, according to the time delay correction described above. Then, the PMT signals are paired (1215) and associated with a given detector based on the time stamp (i.e., the signals have a time stamp within the maximum corrected time for signals from PMTs of the same segment). The energy signal (sum of the energy deposited signals indicated by each PMT) of the signals preferably corrected by the loci dependent light correction efficiency correction described above is determined (1216) and identified as the energy signal of the scintillation. The position of the scintillation, along the length of the segment is determined (1217) based on the one or both of the energy difference between the paired PMT signals or the difference between their corrected time stamps (difference between TOFs). In addition, the determination of whether the scintillation is caused by an interaction with a γ or a neutron, is optionally determined (1218) by the decay time constants or shape difference of the signals. It is well known in the art that in OS, the neutron caused scintillation decay is substantially longer than that caused by a gamma. The information on the scintillations is sent for storage (1220, FIG. 12A) in a scintillation database.

Returning to 1222, FIG. 12D is a simplified block diagram of the process of single incident particle analysis and reconstruction.

First, the scintillations are grouped (1221) in accordance with their time stamps as scintillations that are generated by a single incident gamma or neutron. In practice, all scintillations that occur with a window of −10 Nsec and +20 Nsec of the “first” scintillation are considered as part of the same group, so long as they are geometrically close (e.g., closer than 1 meter apart). Since the time between incident particles is much larger than the time between scintillations, there is only a small chance of overlap of scintillations from different incident particles. In the event that there is such overlap, this in itself could be indicative of a cascaded event, spontaneous fission salvo or an RDD or of a very large unshielded source.

Once the scintillations have been grouped, the total energy (1232) transferred from the incoming event can be determined by summing the individual energy signals of the scintillations in the group.

Separately from the energy determination, the scintillations are sequenced (1223) based on their corrected time stamps. A time stamp for the incident radiation is determined as the first of the sequence of scintillations (1224) and its position of incidence is determined (1225) from the position along the segment as described above (for y) and by the segment in which it appears (x,z).

The sequence is optionally traced (1226) through the detector to determine its path. This path is optionally used to determine (1227) a gross direction of incidence. Depending on the energy, this gross direction can be used for rejecting (1228, 1229) events that are from terrestrial or sky sources and those that enter the detector from the sides other than the front face. For higher energy gamma, for which the scatter is relatively low, the gross direction becomes sharper and may be useful for imaging as well. Alternatively or additionally where collimation is available, a direction of incidence can be derived for one or both of gammas and neutrons, depending on the type and configuration of the collimation as described above.

Furthermore, using the principles described above, with respect to FIG. 9, some of the events can be classified as having escape quanta (1230) and rejected (1231). The particle is then characterized (1233) by (1) its time of incidence; (2) its x, y incident coordinates; (3) its direction of incidence, if available; (4) whether it is a neutron or an gamma; and (5) its energy (if a gamma). This information is sent to 1240 for storage.

Returning to 1240, FIG. 12E is a simplified block diagram of actions performed in single modality threat detection. It is noted that different detector configurations are generally needed for optimizing these single modalities. For example, if collimation is used, the event capture efficiency is reduced and the gamma spectroscopy and coincidence (doublet, triplet and γ/N coincidence) signature detection are degraded. On the other hand, when collimation is used the ability to determine where the threat is in the vehicle and whether it is a small source (and thus more probably an SNM or RDD) is enhanced. Thus, it may be useful to have more than one detector each with different capabilities. A second detector can be used to screen all of the vehicles/packages or only those that look suspicious when they pass the first detector.

First, information on reconstructed events that are stored is retrieved (1243). To the extent possible (depending on the detector capabilities) related events (for example gammas with a same energy or neutrons) are optionally imaged (1244).

Using the information that is stored in 1240 the following signature/analyses are possible: doublet/triplet coincidence (1245); gamma spectroscopy isotope ID (with or without imaging and on the entire detector or vehicle or only in the area of a possible threat) (1246); image based NORM ID to identify the NORM signature (1247); SNM-RDD “point” source ID (based on the understanding that threats are generally less than 0.5 meters in extent) (1248); neutron counting/imaging (1250); and spontaneous fission γ/N ID, based on the temporal coincidence of a gamma and/or neutron events (1251). When a modality produces an image, then this image can be superimposed on an optical image of the vehicle (1252). All of the generated analyses are sent to a single modality alarm (1260) which compares the level of the individual threats probability and determines if an alarm should be generated based on only a singe threat.

Appropriate ones of these single modality analyses are subject to multi-modal analysis 1264. It is well known in the art of statistics (and in particular in threat analysis) that probability of detection false alarm or overlooked threat rates can be significantly reduced when information from orthogonal sources (or semi-orthogonal sources) are available. Any of the techniques available in the art would appear to be suitable for the present multi-modal analysis. Some of the multimodal analyses include:

image guided gamma spectroscopic SNM-RDD ID;

combined Neutron counting and gamma spectroscopy ID;

doublet detection and Gamma Spectroscopy SNM-RDD-NORM ID;

doublet detection and imaging SNM-RDD-NORM ID; and

fused nuclear and gamma imaging.

FIG. 13 shows a system 1000, in which additional detectors are used to improve capture efficiency. In system 1000, five detectors 1002, 1004, 1006, 1008 and 1010 are used.

As can be seen the additional detectors increase the solid angle subtended by the source. Alternatively to providing five detectors, three detectors (detectors 104 and 108 are omitted and the other detectors are extended to close the gap); four detectors (one detector on each side, one above and one below the vehicle); or eight detectors (an arrangement of three detectors beneath the vehicle similar to that shown in FIG. 14 above the vehicle), may be provided. Other variations of placement will be apparent to the person of skill in the art. These detectors can provide axial tomography and/or linear tomography to better detect threat “point” sources.

FIG. 14, shows a multi-lane system 1100, in which a same detector is used for adjoining lanes. As indicated above, one detector is needed between two lanes, since the detector can discriminate between incident events which come from different directions. Thus, only N+1 detectors are required for a multi-lane checkpoint portal having N lanes.

It should be noted that while the invention is described herein as using at least two detectors, in some embodiments of the invention, a single detector can be used, with reduced sensitivity/efficiency. Alternatively, more than two detectors can be placed around the path of the vehicle, such as top, bottom and two sides. Such detectors can not only improve SNM-RDD detection sensitivity but can also shield against environmental and foreign background radiation, resulting in further improved ROC.

While the preferred OS is a liquid OS, in some embodiments of the invention a plastic OS, such as PVT can be used.

Although the detectors are described in the context of passive detection of nuclear threats, in some embodiments of the invention, the large detector is used as a gamma and/or neutron detector of active portals.

Although the detectors are described in the context of threat detection of SNM-RDD devices and radioactive materials carried on vehicles, in some embodiments the large OS detectors are used to screen supply chain articles (e.g. containers, pallets, air cargo, mail bags, etc.)

While described explicitly, corrections known in the art, such as background correction, can be applied in portals using detectors of the present invention.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A detector for detecting nuclear radiation threats, the detector comprising: a plurality of organic scintillator [OS] polygonal segments arranged in a side by side array; and at least one pair of light sensors optically coupled to ends of each of the scintillator polygonal segments such that they receive light from scintillations produced in the scintillator segments and generate electrical signals responsive thereto

2. A detector according to claim 1 wherein the organic scintillator is a liquid organic scintillator

3. A detector for detecting nuclear radiation threats, the detector comprising: a plurality of elongated organic scintillator segments arranged in a side by side array; and at least one pair of light sensors optically coupled to ends of each of the scintillator segments such that they receive light from scintillations produced in the scintillator segments and generate electrical signals responsive thereto wherein at least one of said segments is loaded with material which reduces the rate of escape quanta

4. A detector according to claim 3 wherein the organic scintillator is a liquid organic scintillator.

5. A detector for detecting nuclear radiation threats, the detector comprising: a plurality of elongated organic scintillator segments arranged in a side by side array; and at least one pair of light sensors optically coupled to ends of each of the scintillator segments such that they receive light from scintillations produced in the scintillator segments and generate electrical signals responsive thereto wherein at least one OS segment consists of gamma spectroscopy favored OS and at least one segment consists of gamma-neutron identification PSD favored OS

6. A detector according to claim 5 wherein the organic scintillator is a liquid organic scintillator.

7. A detector for detecting nuclear radiation threats, the detector comprising: a plurality of elongated organic scintillator segments arranged in a side by side array; and at least one pair of light sensors optically coupled to ends of each of the scintillator segments such that they receive light from scintillations produced in the scintillator segments and generate electrical signals responsive thereto wherein at least one set of segments is used to both collimate other segments and detect radiation.

8. A detector according to claim 7 wherein the organic scintillator is a liquid organic scintillator

9. A detector for detecting nuclear radiation threats, the detector comprising: a plurality of elongated organic scintillator segments arranged in a side by side array; and at least one pair of light sensors optically coupled to ends of each of the scintillator segments such that they receive light from scintillations produced in the scintillator segments and generate electrical signals responsive thereto wherein at least one layer of light transparent material having an index of refraction greater than the index of refraction of the scintillator is coupled to at least one said scintillator segment.

10. A detector according to claim 9 wherein the organic scintillator is a liquid organic scintillator

11. A nuclear radiation threats screening portal having at least one detector mounted vertically to two screening lanes wherein said portal enables the simultaneous screening of at least two items each traveling on a separate lane. said portal having at least one organic scintillation detector comprising: a plurality of elongated organic scintillator segments arranged in a side by side array; Wherein said vertical detector identifies the detector entry side of incident gamma particles

12. A detector according to claim 11 wherein the organic scintillator is a liquid organic scintillator.

13. A nuclear radiation threats screening portal having at least one detector mounted vertically to two screening lanes wherein said portal enables the simultaneous screening of at least two items each traveling on a separate lane, said portal having at least one organic scintillation detector comprising: a plurality of elongated organic scintillator segments arranged in a side by side array; Wherein said vertical detector identifies the detector entry side of incident neutron particles

14. A detector according to claim 13 wherein the organic scintillator is a liquid organic scintillator

15. A SNM, RDD radiation screening portal having at least one detector mounted substantially in parallel, above and or below the screened object lane wherein said detector comprising: a plurality of elongated organic scintillator segments arranged in a side by side array

16. A detector according to claim 15 wherein the organic scintillator is a liquid organic scintillator

17. A detector according to claim 2 wherein the scintillator segments are at least partly non-contiguous.

18. A detector according to claim 4 wherein the scintillator segments are at least partly non-contiguous.

19. A detector according to claim 6 wherein the scintillator segments are at least partly non-contiguous.

20. A detector according to claim 6 wherein the scintillator segments are at least partly non-contiguous.

21. A detector according to claim 8 wherein the scintillator segments are at least partly non-contiguous.

22. A detector according to claim 10 wherein the scintillator segments are at least partly non-contiguous.

23. A detector according to claim 12 wherein the scintillator segments are at least partly non-contiguous.

24. A detector according to claim 14 wherein the scintillator segments are at least partly non-contiguous.

25. A detector according to claim 16 wherein the scintillator segments are at least partly non-contiguous.

26. A detector according to claim 2 and comprising: a plurality of collimators on a face of the organic scintillator that block radiation that would be detected by the said detector from parts of the radiation field.

27. A detector according to claim 4 and comprising: a plurality of collimators on a front face of the organic scintillator that block radiation that would be detected by the said detector from parts of the radiation field.

28. A detector according to claim 6 and comprising: a plurality of collimators on a front face of the organic scintillator that block radiation that would be detected by the said detector from parts of the radiation field.

29. A detector according to claim 8 and comprising: a plurality of collimators on a front face of the organic scintillator that block radiation that would be detected by the said detector from parts of the radiation field.

30. A detector according to claim 10 and comprising: a plurality of collimators on a front face of the organic scintillator that block radiation that would be detected by the said detector from parts of the radiation field.

31. A detector according to claim 12 and comprising: a plurality of collimators on a front face of the organic scintillator that block radiation that would be detected by the said detector from parts of the radiation field.

32. A detector according to claim 14 and comprising: a plurality of collimators on a front face of the organic scintillator that block radiation that would be detected by the said detector from parts of the radiation field.

33. A detector according to claim 16 and comprising: a plurality of collimators on a front face of the organic scintillator that block radiation that would be detected by the said detector from parts of the radiation field.

34. A detector according to claim 2 and also comprising: a controller that receives the electrical signals and generates an image of the sources of radiation that cause the scintillations.

35. A detector according to claim 2, wherein the scintillator produces scintillations responsive to incoming neutrons, and further comprising: a controller that receives the electrical signals and determines the positions of the incident neutrons on the detector.

36. A detector according to claim 4 and also comprising: a controller that receives the electrical signals and generates an image of the sources of radiation that causes the scintillations.

37. A detector according to claim 4, wherein the scintillator produces scintillations responsive to incoming neutrons, and further comprising: a controller that receives the electrical signals and determines the positions of the incident neutrons on the detector.

38. A detector according to claim 6 and also comprising: a controller that receives the electrical signals and generates an image of the sources of radiation that causes the scintillations.

39. A detector according to claim 6, wherein the scintillator produces scintillations responsive to incoming neutrons, and further comprising: a controller that receives the electrical signals and determines the positions of the incident neutrons on the detector.

40. A detector according to claim 8 and also comprising: a controller that receives the electrical signals and generates an image of the sources of radiation that cause the scintillations.

41. A detector according to claim 8, wherein the scintillator produces scintillations responsive to incoming neutrons, and further comprising: a controller that receives the electrical signals and determines the positions of the incident neutrons on the detector.

42. A detector according to claim 10 and also comprising: a controller that receives the electrical signals and generates an image of the sources of radiation that cause the scintillations.

43. A detector according to claim 10, wherein the scintillator produces scintillations responsive to incoming neutrons, and further comprising: a controller that receives the electrical signals and determines the positions of the incident neutrons on the detector.

44. A detector according to claim 12 and also comprising: a controller that receives the electrical signals and generates an image of the sources of radiation that cause the scintillations.

45. A detector according to claim 12, wherein the scintillator produces scintillations responsive to incoming neutrons, and further comprising: a controller that receives the electrical signals and determines the positions of the incident neutrons on the detector.

46. A detector according to claim 14 and also comprising: a controller that receives the electrical signals and generates an image of the sources of radiation that cause the scintillations.

47. A detector according to claim 14, wherein the scintillator produces scintillations responsive to incoming neutrons, and further comprising: a controller that receives the electrical signals and determines the positions of the incident neutrons on the detector.

48. A detector according to claim 16 and also comprising: a controller that receives the electrical signals and generates an image of the sources of radiation that causes the scintillations.

49. A detector according to claim 16, wherein the scintillator produces scintillations responsive to incoming neutrons, and further comprising: a controller that receives the electrical signals and determines the positions of the incident neutrons on the detector.

50. A system for detection of radiation signatures of SNM and RDD devices and materials from a screened object, comprising: at least one organic scintillator which produces scintillations when impinged by gamma and neutron radiation; a plurality of optical sensors optically coupled to the at least one scintillator such that they receive light from scintillations produced in the scintillator and generate electrical signals responsive thereto; and a controller that receives the signals and performs a multi-signature detection of threats including a plurality of the following threat detection inputs or characterizations:
a) gamma spectroscopy isotope signature;
b) Gamma imaging morphologic signature;
c) neutron counting;
d) neutron imaging;
e) cascaded isotopes doublets or triplets signature;
f) SNM spontaneous fission neutron multiplets signature;
g) comparison with optical images of the screened object; and
h) gross directionality of incidence of radiation as compared to the direction of the screened object.
i) [i] SNM spontaneous fission gamma multiplets signature
j) [j]. SNM spontaneous fission gamma and neutron multiplets signature
k) [k] muon induced high z elements neutron signature
l) [L] muon induced high z elements gamma signature
m) [m] muon induced high z elements x-ray signature
n) [n] energy windowed gamma counting
o) [O] CCTV imaging of screened object
